(19) United States
(12) Patent Application Publication
(10) Pub. No.: US 2019/0384895 A1
(43) Pub. Date: Dec. 19, 2019

(54) SYSTEM FOR DOCUMENT AND CERTIFICATE MANAGEMENT USING DIRECTED ACYCLIC GRAPH BASED TAGGING

(71) Applicant: Ivy Food Technology, Inc., San Francisco, CA (US)

(72) Inventors: Nathan JIN, San Francisco, CA (US); Patrick Zhang, Los Gatos, CA (US); George Wu, Redmond, WA (US)

(73) Assignee: Ivy Food Technology, Inc., San Francisco, CA (US)

(21) Appl. No.: 16/292,478

(22) Filed: Mar. 5, 2019

Related U.S. Application Data
(60) Provisional application No. 62/687,081, filed on Jun. 19, 2018.

(51) Int. Cl. G06F 21/16; G06F 17/27; G06F 17/28; G06F 16/35; G06F 16/81

(52) U.S. Cl. CPC G06F 21/16; G06F 17/2705; G06F 16/81; G06F 16/353; G06F 17/28

(57) ABSTRACT

An enterprise software system designed for documentation and certification in inventory/merchandise systems. Specifically, the design of permissioning of multiple documents or files to multiple entities, products or locations for fast user controls and access. Natural language processing allows the system to parse information from files and store information in a higher level datastructure, essentially creating a fileless system. Permissioning control then handles the recombination of such information into the format needed by the receiver, eliminating the need to standardize. Further, information can be validated in a new way that has not been possible before through blockchain and zero knowledge proofs. The system enables the actors to access information while removing threats of disintermediation by concealing identity but proving ownership and authenticity of information.

### RELATED APPLICATION DATA

This application claims the benefit of priority to U.S. Provisional Application No. 62/687,081, filed on Jun. 19, 2018. The entire contents of each of the above-identified applications are hereby incorporated by reference.

### FIELD OF THE INVENTION

The present disclosure generally relates to an enterprise software system designed for document and certificate management in business (merchandise, inventory, etc.) systems which with eventual extension(s) of the system should lead to a “file-less” system. Specifically, the design of permissioning of multiple documents or files to multiple entities, with a tag(s) based directed acyclic graph for fast user controls, retrieval and access. Natural language processing also allows the system to parse information from files and store information in a higher-level data structure, essentially creating a folderless system. Furthermore, permissioning control handles the recombination of such information into the format needed by the receiver, eliminating the need to standardize foundation of the system. Further, information can be validated in a new way that has not been possible before through blockchain and zero knowledge proofs. For example, the system/method disclosed herein can enable users (e.g., the actors) to access information while removing threats of disintermediation by concealing identity but proving ownership and authenticity of information. More specifically, the present disclosure generally relates to methods, systems, computer program products, etc. relating to an enterprise software system designed for documentation and certification management in business (merchandise, inventory, etc.) systems. For illustration purposes, the present disclosure provides embodiments focused on the food industry for simplicity, the present invention is not limited to any way to a specific industry.

### SUMMARY

This Summary introduces a selection of concepts in a simplified form in order to provide a basic understanding of some aspects of the present disclosure. This Summary is not an extensive overview of the disclosure, and is not intended to identify key or critical elements of the disclosure or to delineate the scope of the disclosure. This Summary merely presents some of the concepts of the disclosure as a prelude to the Detailed Description provided below.

In an embodiment, an apparatus (and/or method and/or non-transitory computer readable medium) comprising at least a receiving circuit and/or device configured and/or programmed to receive at least: a first document from a first user, wherein the first user is at a first location, a second document from a second user, wherein the second user is at a second location, and a third document from a third user, wherein the third user is at a third location; a partitioning circuit and/or device configured and/or programmed to at least: receive said first document, said second document and said third document from said receiving circuit and/or device, perform character recognition on said first document to produce a first result being a first text document, perform character recognition on said second document to produce a second result being a second text document, perform character recognition on said third document to produce a third result being a third text document, automatically defining fields produced by text in said first document, said second document and said third document; automatically assigning tags based on said fields produced to said first document, said second document and said third document, wherein at least a first tag is assigned to said first document based on a first field produced from the first document, at least a second tag is assigned to said second document based on a second field produced, and at least a third tag is assigned to said third document based on a third field produced; and a storage circuit and/or device configured and/or programmed to store at least: the first document that is tagged with the first tag, the second document that is tagged with the second tag, and the third document that is tagged with the third tag.

According to an embodiment, the apparatus further comprising at least a transmitting and/or displaying circuit and/or device, based on receiving a single instruction to i) transmit documents tagged with the first tag and the second tag to one of the first user, the second user, the third user, a fourth user or a fifth user and to ii) transmit documents tagged with the second tag and the third tag to another of the first user, the second user, the third user, the fourth user or the fifth user, configured and/or programmed to: simultaneously transmit: said first document and said second document which are individually tagged with the first tag and the second tag to said one of the first user, the second user, the third user, the fourth user or the fifth user, and said second document and said third document which are individually tagged with the second tag and the third tag to said another of the first user, the second user, the third user, the fourth user or the fifth user.

In an embodiment, the apparatus further comprising at least a transmitting and/or displaying circuit and/or device configured and/or programmed to simultaneously transmit a plurality of documents to a recipient user in response to receiving i) a selection of a plurality of tags and ii) a selection of the recipient user.

In an embodiment, the apparatus further comprising at least a transmitting and/or displaying circuit and/or device configured and/or programmed to simultaneously transmit a plurality of documents to a plurality of recipient users in response to receiving i) a selection of a plurality of tags and ii) a selection of the plurality of recipient users.

In an embodiment, the storage circuit and/or device is configured and/or programmed to store a fourth document that is tagged with a fourth tag, said first tag is assigned as a parent tag to said second tag, said fourth tag is assigned as a child tag to said second tag, said third tag is assigned as a parent tag to said fourth tag; a transmitting and/or displaying circuit and/or device is configured and/or programmed to: transmit and/or display said second document in response to one of the first user, the second user, the third user, a fourth user or a fifth user selecting the first tag, transmit and/or display said fourth document in response to said one of the first user, the second user, the third user, the fourth user or the fifth user selecting the second tag, and transmit and/or display said fourth document in response to another of the first user, the second user, the third user, the fourth user or the fifth user selecting the third tag.

In an embodiment, the transmitting and/or displaying circuit and/or device is configured and/or programmed to transmit and/or display said fourth document in response to another of the first user, the second user, the third user, the fourth user or the fifth user selecting the fourth tag.

In an embodiment, said first tag is assigned as a parent tag to said second tag; and a transmitting and/or displaying circuit and/or device is configured and/or programmed to: transmit and/or display said second document in response to one of the first user, the second user, the third user, a fourth user or a fifth user selecting the second tag after selecting the first tag, and transmit and/or display said second document in response to another of the first user, the second user, the third user, a fourth user or a fifth user selecting only the second tag.

In an embodiment, said first tag is assigned as a parent tag to said second tag; and a transmitting and/or displaying circuit and/or device is configured and/or programmed to: transmit and/or display said second document in response to one of the first user, the second user, the third user, a fourth user or a fifth user selecting the second tag after selecting the first tag, and transmit and/or display said second document in response to another of the first user, the second user, the third user, a fourth user or a fifth user selecting the second tag without a selection of the first tag.

In an embodiment, the apparatus in a system that further comprises at least a controller circuit and/or device configured and/or programmed to: assign a unique ID to each user associated with the system, generate an identification of a piece of data to uniquely identify a document or a piece of document information in response to the document or the piece of document information being posted or stored in said storage circuit and/or device, and determine and/or confirm whether data of said first document has been changed by comparing a newly generated identification for said first document to a previously generated identification for said first document.

In an embodiment, the apparatus in a system that further comprises at least a controller circuit and/or device configured and/or programmed to: assign a unique ID to each user associated with the system, and generate an identification of a piece of data to uniquely identify a document or a piece of document information in response to the document or the piece of document information being posted or stored in said storage circuit and/or device, subsequent publication of the unique identifier of the piece of data to an immutable record, then at any time a user may determine and/or confirm whether data of said first document has been changed by comparing a newly generated identification for said first document to a previously generated identification for said first document.

In an embodiment, the storage circuit and/or device is configured and/or programmed to store a fourth document that is tagged with a fourth tag, said first tag is assigned as a parent tag to said second tag, said fourth tag is assigned as a child tag to said second tag, and the receiving circuit and/or device is configured and/or programmed to receive a tagging instruction from a user; and the apparatus further comprising: a controller circuit and/or device configured and/or programmed to block or restrict the ability to assign a tagging relationship where either i) the first tag is to be a child tag of the fourth tag or ii) the fourth tag is to be a parent tag of the first tag.

In an embodiment, the apparatus further comprising at least a transmitting and/or displaying circuit and/or device configured and/or programmed to transmit and/or display an error message in response to the controller blocking or restricting the ability to assign the tagging relationship where either i) the first tag is to be a child tag of the fourth tag or ii) the fourth tag is to be a parent tag of the first tag.

In an embodiment, an apparatus (and/or method and/or non-transitory computer readable medium) for handling document request templates, the apparatus comprising: at least a receiving circuit and/or device configured and/or programmed to receive: at least a set of documents from a first user, and a value corresponding to N number of template slots to be used in a template; and a transmitting circuit and/or device configured and/or programmed to transmit the template with at least said set of documents to a second user, wherein at least one document is sent in at least one of said N template slots, said set of documents includes at least N documents, the template includes N template slots, N being a value equal to or greater than 1, said receiving circuit and/or device is configured and/or programmed to receive an edited template from the second user, an assignment circuit and/or device configured and/or programmed to assign temporary tag(s) to each individual template slot of the set of documents based on the edited template received from the second user, said transmitting circuit and/or device is configured and/or programmed to transmit, to the second user, the assigned temporary tags, said receiving circuit and/or device is configured and/or programmed to receive, from the second user, permanent tag(s) being edited version of said temporary tag(s), and said assignment circuit and/or device is configured and/or programmed to assign the permanent tag(s) to said set of documents by adding, deleting, and/or replacing tag assignments.

In an embodiment, an apparatus (and/or method and/or non-transitory computer readable medium) for handling document request templates, the apparatus comprising at least a communication circuit and/or device configured and/or programmed to: receive, from a first user, a value corresponding to N number of template slots to be used in a template, receive, from the first user, a first assignment or a first label corresponding to a first slot, receive, from the first user, a second assignment or a second label corresponding to a second slot, receive, from the first user, a first tag corresponding to the first slot, receive, from the first user, a second tag corresponding to the second slot, receive, from the first user, a third tag corresponding to all of said N slots, receive, from a second user, a first document or a first set of documents corresponding to the first slot, and receive, from the second user, a second document or a second set of documents corresponding to the second slot; and a controller circuit and/or device configured and/or programmed to: automatically convert and assign the first assignment or the first label as a fourth tag to said received first document or said received first set of documents corresponding to the first slot, automatically convert and assign the second assignment or the second label as a fifth tag to said received second document or said received second set of documents corresponding to the second slot, automatically assign the first tag to said received first document or said received first set of documents corresponding to the first slot, automatically assign the second tag to said received second document or said received second set of documents corresponding to the second slot, and automatically assign the third tag to both said received first document or said received first set of documents corresponding to the first slot and said received second document or said received second set of documents corresponding to the second slot.

In an embodiment, the communication circuit and/or device configured and/or is further programmed to receive, from the first user, a sixth tag that the first user assigned only to the second user at the time the first user sent the template to the second user, and the controller circuit and/or device configured and/or is further programmed to automatically assign the sixth tag to all documents or all set of documents received from the second user that the first user send via the template, and said all documents received or said all set of documents received from the second user includes at least said received first document or said received first set of documents and said received second document or said received second set of documents.

In an embodiment, said controller circuit and/or device configured and/or is further programmed to automatically assign the sixth tag to said all documents or said all set of documents received from the second user that the first user send via the template only in response to the communication circuit and/or device and receive an acknowledgement from the first user that the system is permitted to accept the second user's submission of aid all documents or said all set of documents received from the second user.

In an embodiment, an apparatus (and/or method and/or non-transitory computer readable medium)

In an embodiment, for a file sharing, retrieval and management system using hierarchical tagging with permissions, the apparatus comprising at least a hierarchical list of tags; a plurality of files; a hierarchical tag management facility; and a tag permissions facility; wherein each of said plurality of files is tagged by one or more tags in said hierarchical list of tags, said hierarchical tag facility is used to create and manage said hierarchical list of tags, said tag permissions facility is activated in response to an administrator selecting one or multiple tags, said administrator is a user having rights to facilities to configure said file sharing system, said tags permissions facility is used to change permissions to one or more groups of users to access one or more files tagged with a selected set of tags, said hierarchical list of tags includes child tags and parent tags, and said hierarchical list of tags restricts assignment of a child tag to be given to any ancestry parent tags and said hierarchical list of tags restricts assignment of a parent tag to be given to any direct heir tags to ensure hierarchical list of tags is structured only as a directed acyclic graph structure that does not form a cycle or a closed loop between any tag relationships.

In an embodiment, a method (and/or a non-transitory computer readable medium having instructions stored thereon, such that when the instructions are read and executed by one or more processors, said one or more processors is configured to performing said method) comprising at least the steps of receiving a first document from a first user, wherein the first user is at a first location; receiving a second document from a second user, wherein the second user is at a second location; receiving a third document from a third user, wherein the third user is at a third location; performing character recognition on said first document to produce a first result being a first text document; performing character recognition on said second document to produce a second result being a second text document; performing character recognition on said third document to produce a third result being a third text document; automatically defining fields produced by text in said first document, said second document and said third document; automatically assigning tags based on said fields produced to said first document, said second document and said third document, wherein at least a first tag is assigned to said first document based on a first field produced from the first document, at least a second tag is assigned to said second document based on a second field produced, and at least a third tag is assigned to said third document based on a third field produced; storing the first document that is tagged with the first tag; storing the second document that is tagged with the second tag; and storing the third document that is tagged with the third tag.

In an embodiment, a method (and/or a non-transitory computer readable medium having instructions stored thereon, such that when the instructions are read and executed by one or more processors, said one or more processors is configured to performing said method) for handling document request templates comprising at least the steps of receiving at least a set of documents from a first user; receiving a value corresponding to N number of template slots to be used in a template; transmitting the template with at least said set of documents to a second user, wherein at least one document is sent in at least one of said N template slots, said set of documents includes at least N documents, the template includes N template slots, N being a value equal to or greater than 1; receiving an edited template from the second user; assigning temporary tag(s) to each individual template slot of the set of documents based on the edited template received from the second user; transmitting, to the second user, the assigned temporary tags; receiving, from the second user, permanent tag(s) being edited version of said temporary tag(s); and assigning the permanent tag(s) to said set of documents by adding, deleting, and/or replacing tag assignments.

In an embodiment, a method (and/or a non-transitory computer readable medium having instructions stored thereon, such that when the instructions are read and executed by one or more processors, said one or more processors is configured to performing said method) for handling document request templates comprising at least the steps of receiving, from a first user, a value corresponding to N number of template slots to be used in a template; receiving, from the first user, a first assignment corresponding to a first slot; receiving, from the first user, a second assignment corresponding to a second slot; receiving, from the first user, a first tag corresponding to the first slot; receiving, from the first user, a second tag corresponding to the second slot; receiving, from the first user, a third tag corresponding to all of said N slots; receiving, from a second user, a first document or a first set of documents corresponding to the first slot; receiving, from the second user, a second document or a second set of documents corresponding to the second slot; automatically converting and assigning the first assignment as a fourth tag to said received first document or said received first set of documents corresponding to the first slot; automatically converting and assigning the second assignment as a fifth tag to said received second document or said received second set of documents corresponding to the second slot; automatically assigning the first tag to said received first document or said received first set of documents corresponding to the first slot; automatically assigning the second tag to said received second document or said received second set of documents corresponding to the second slot; and automatically assigning the third tag to both said received first document or said received first set of documents corresponding to the first slot and said received second document or said received second set of documents corresponding to the second slot.

In an embodiment, a method (and/or a non-transitory computer readable medium having instructions stored thereon, such that when the instructions are read and executed by one or more processors, said one or more processors is configured to performing said method) for a file sharing, retrieval and management system using hierarchical tagging with permissions comprising at least the steps of tagging each of a plurality of files by one or more tags in a hierarchical list of tags, wherein said hierarchical tag facility is used to create and manage said hierarchical list of tags; changing permissions to one or more groups of users to access one or more files tagged with a selected set of tags, wherein said hierarchical list of tags includes child tags and parent tags; and restricting assignment of a child tag to be given to any ancestry parent tags and said hierarchical list of tags restricts assignment of a parent tag to be given to any direct heir tags to ensure hierarchical list of tags is structured only as a directed acyclic graph structure that does not form a cycle or a closed loop between any tag relationships.

In another embodiment, an apparatus (and/or method and/or non-transitory computer readable medium) comprising: a transmitting circuit or device configured and/or programmed to forward a document; a meta data storage structure configured and/or programmed to directly and/or indirectly receive information from said transmitting circuit or device and store field mapping in a defined field structure; and a database circuit or device configured and/or programmed to include a format for data organization where the document file structure having a webbed node pattern.

According to another embodiment, the document is a data structure that stores information in a single entity.

In another embodiment, the system includes an partitioning circuit or device comprising at least an OCR circuit or device, a text processing circuit or device, and an language processing circuit or device, wherein the OCR circuit or device configured and/or programmed to receive said document from said transmitting circuit or device, wherein said OCR circuit or device configured and/or programmed to perform an OCR on said document in a case where the anon-text pdf and/or a scanned image of a document or image is received, the text processing circuit or device configured and/or programmed to define fields produced by the text in the document, the language processing circuit or device configured and/or programmed to determine the type of document and match fields in the general document type to the information in the document to suggest tags, and the partitioning circuit or device is configured to partition the document into n individual pieces where n is greater than or equal to 2.

In another embodiment, at least three object classes for storage in the meta data storage structure are defined, the at least three object classes include people information, product information, and location information.

In another embodiment, the meta data storage is composed of a directed acyclic graph system composed of tags for nodes and documents as endpoints, in which the tags are used for rapid retrieval, organization and filtering of documents. Traversal of the graph is cyclic, but implementation is directed, meaning relationships between objects are directed and acyclic.

In another embodiment, the system further includes a receiver validation circuit or device configured and/or programmed to perform validation for the information stored in the meta data storage structure; a blockchain circuit or device configured and/or programmed for immutability in a case where a hash of information is generated when a document or document information piece is posted to the apparatus; a user identity validation circuit or device configured and/or programmed to perform validation on a user's identify; and a certificate generation circuit or device configured and/or programmed to hash the transaction of the granting of the document from the agency to the recipient in the case where a certifier granting documents to a certificate recipient, where both the certifying agency's and the recipient identity are recorded and hashed.

In yet another embodiment, the system includes an alert and notification circuit or device configured and/or programmed to automatically generate alerts based off of conditional triggers, wherein conditional triggers include one of days until document expiration or document rejection by a receiver.

In another embodiment, the system includes a search circuit or device configured and/or programmed to implement a search across any attribute field of an object, and/or to implement a relational search across object associations established in the system.

In another embodiment, the system includes a signature system circuit or device configured and/or programmed to implement a signature system on top of document versioning to control document distribution internally to users in an organization.

In another embodiment, the system includes a composite information document generation circuit or device configured and/or programmed to store individual data components received from the database circuit or device.

In another embodiment, the system includes an autofill circuit or device configured and/or programmed to autofill information.

Further scope of applicability of the present invention will become apparent from the Detailed Description given below. However, it should be understood that the Detailed Description and specific examples, while indicating preferred embodiments of the invention, are given by way of illustration only, since various changes and modifications within the spirit and scope of the invention will become apparent to those skilled in the art from this Detailed Description.

### BRIEF DESCRIPTION OF DRAWINGS

These and other objects, features and characteristics of the present disclosure will become more apparent to those skilled in the art from a study of the following Detailed Description in conjunction with the appended claims and drawings, all of which form a part of this specification. In the drawings:

FIG. 1 is an illustration of a basic document tree structure.

FIG. 2 is an illustration of a cyclic structure according to at least one embodiment.

FIG. 3 is an illustration of a cyclic structure according to at least one embodiment.

FIG. 4 is an illustration of a cyclic structure according to at least one embodiment.

FIG. 5 is a graph system for an example case of storing organic certificates using a tag-based system compared to a standard system according to at least one embodiment.

FIG. 6 is a cyclic graph system for the disclosed case of storing organic certificates according to at least one embodiment.

FIG. 7 is a cyclic graph system for the disclosed case of storing organic certificates according to at least one embodiment.

FIG. 8 is a flow diagram/system schematic of the platform of the system designed for documentation and certification in business (e.g. food) systems according to at least one embodiment.

FIG. 9 is a receiver process according to at least one embodiment.

FIG. 10 is a flow diagram/system schematic of the platform of the system designed for documentation and certification in business (e.g. food) systems according to at least one embodiment.

FIG. 11 is a spheroid tag-based document filtering diagram/process according to at least one embodiment.

FIG. 12 is a machine learning loop for system generated tags according to at least one embodiment.

FIG. 13(a) is an example flow diagram of a user process in the system according to at least one embodiment.

FIG. 13(b) is an illustration of user roles according to at least one embodiment used with at least FIG. 13.

FIG. 14(a) is an illustration of user uploads according to at least one embodiment used with at least FIG. 13.

FIG. 14(b) is an illustration of user metadata editing according to at least one embodiment used with at least FIG. 13.

FIG. 14(c) is an illustration of version history processing according to at least one embodiment used with at least FIG. 13.

FIG. 14(d) is an illustration of user queries of document(s) according to at least one embodiment used with at least FIG. 13.

FIG. 15(a) is an illustration of tracking expiration date according to at least one embodiment used with at least FIG. 13.

FIG. 15(b) is an illustration of Blockchain validation of documents according to at least one embodiment used with at least FIG. 13.

FIG. 15(c) is an illustration of management of tags according to at least one embodiment used with at least FIG. 13.

FIG. 16(a) is an illustration of document requesting procedure according to at least one embodiment used with at least FIG. 13.

FIG. 16(b) is an illustration of user document sending/transmitting procedure according to at least one embodiment used with at least FIG. 13.

FIG. 17 is a circuit diagram of one aspect of a computing device/controller 1000 that works in conjunction with the elements of the present disclosure

The headings provided herein are for convenience only and do not necessarily affect the scope or meaning of the claimed invention.

In the drawings, the same reference numerals and any acronyms identify elements or acts with the same or similar structure or functionality for ease of understanding and convenience. The drawings will be described in detail in the course of the following Detailed Description.

### DETAILED DESCRIPTION

This disclosure is not limited to the particular systems, devices and methods described, as these may vary. The terminology used in the description is for the purpose of describing the particular versions or embodiments only, and is not intended to limit the scope. Various examples of the invention will now be described. The following description provides specific details for a thorough understanding and enabling description of these examples. One skilled in the relevant art will understand, however, that the invention may be practiced without many of these details. Likewise, one skilled in the relevant art will also understand that the invention can include many other obvious features not described in detail herein. Additionally, some well-known structures or functions may not be shown or described in detail herein, so as to avoid unnecessarily obscuring the relevant description.

Descriptions of well-known starting materials, processing techniques, components and equipment may be omitted so as not to unnecessarily obscure the invention in detail. It should be understood, however, that the detailed description and the specific examples, while indicating (e.g., preferred) embodiments of the invention, are given by way of illustration only and not by way of limitation. Various substitutions, modifications, additions and/or rearrangements within the spirit and/or scope of the underlying inventive concept will become apparent to those skilled in the art from this disclosure. Embodiments discussed herein can be implemented in suitable computer-executable instructions that may reside on a computer readable medium (e.g., a hard disk drive, flash drive or other memory), hardware circuitry or the like, or any combination.

Before discussing specific embodiments, embodiments of a hardware architecture for implementing certain embodiments is described herein. One embodiment can include one or more computers communicatively coupled to a network. As is known to those skilled in the art, the computer can include a central processing unit (“CPU”), at least one read-only memory (“ROM”), at least one random access memory (“RAM”), at least one hard drive (“HD”), and one or more input/output (“I/O”) device(s). The I/O devices can include a keyboard, monitor, printer, electronic pointing device (such as a mouse, trackball, stylus, etc.) or the like. In various embodiments, the computer has access to at least one database over the network.

ROM, RAM, and HD are computer memories for storing data and computer-executable instructions executable by the CPU. Within this disclosure, the term “computer-readable medium” is not limited to ROM, RAM, and HD and can include any type of data storage medium that can be read by a processor. In some embodiments, a computer-readable medium may refer to a data cartridge, a data backup magnetic tape, a floppy diskette, a flash memory drive, an optical data storage drive, a CD-ROM, ROM, RAM, HD, or the like.

At least portions of the functionalities or processes described herein can be implemented in suitable computer-executable instructions. The computer-executable instructions may be stored as software code components or modules on one or more computer readable media (such as non-volatile memories, volatile memories, DASD arrays, magnetic tapes, floppy diskettes, hard drives, optical storage devices, etc. or any other appropriate computer-readable medium or storage device). In one embodiment, the computer-executable instructions may include lines of compiled C++, Java, HTML, or any other programming or scripting code.

Additionally, the functions of the disclosed embodiments may be implemented on one computer or shared/distributed among two or more computers in or across a network. Communications between computers implementing embodiments can be accomplished using any electronic, optical, radio frequency signals, or other suitable methods and tools of communication in compliance with known network protocols.

As used herein, the terms “comprises,” “comprising,” “includes,” “including,” “has,” “having” or any other variation thereof, are intended to cover a non-exclusive inclusion. For example, a process, article, or apparatus that comprises a list of elements is not necessarily limited to only those elements but may include other elements not expressly listed or inherent to such process, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

As used in this document, the singular forms “a,” “an,” and “the” include plural references unless the context clearly dictates otherwise. Unless defined otherwise, all technical and scientific terms used herein have the same meanings as commonly understood by one of ordinary skill in the art. Nothing in this disclosure is to be construed as an admission that the embodiments described in this disclosure are not entitled to antedate such disclosure by virtue of prior invention.

A “user” refers to one or more entities or people using any of the components and/or elements thereof as described herein. In some embodiments, the user may be a user of an electronic device. In other embodiments, the user may be a user of a computing device. Users described herein are generally either creators of content, managers of content, merchants, or consumers. For example, a user can be an administrator, a developer, a group of individuals, a content provider, a consumer, a merchant, a representative of another entity described herein, and/or the like.

An “item”, a “product”, “merchandise” or similar terminology are all goods and/or services that may be available for purchase. For example, the item, product, or merchandise may be a food item (produce, etc.) an article of clothing, a fashion accessory, a household good, an electronic device, a car, an airline ticket, a hotel reservation, an event ticket, an insurance policy, property, repair services, and/or any other good or service. Items, products, and merchandise are generally used interchangeably herein, and therefore a discussion of one or more of the terms is meant to include any or all of the terms.

Additionally, any examples or illustrations given herein are not to be regarded in any way as restrictions on, limits to, or express definitions of, any term or terms with which they are utilized. Instead, these examples or illustrations are to be regarded as being described with respect to one particular embodiment and as illustrative only. Those of ordinary skill in the art will appreciate that any term or terms with which these examples or illustrations are utilized will encompass other embodiments which may or may not be given therewith or elsewhere in the specification and all such embodiments are intended to be included within the scope of that term or terms. Language designating such nonlimiting examples and illustrations include, but is not limited to: “for example,” “for instance,” “e.g.,” “in one embodiment.”

The present system/method is an enterprise software application designed for document and certificate handling, for both internal management and organization of documents as well as external sending and receiving of documents. The product in its fundamental form allows an user to manage the controls and permissioning for multiple documents to (a receiver or) multiple receivers, as well as enabling fast retrieval and management for document control. However, while a user manages the controls and permissioning for (a single document and/or) multiple documents to (a single receiver and/or) multiple receivers, only a single copy of any given document is maintained, and a versioning history is maintained for updates to a document (e.g., the single copy of said given document). As a result, this creates a single source of information (e.g., the single copy of said given document) in which each of the receivers do not create a duplicate copy and instead only receive a pointer to a document (e.g., the single copy of said given document). Pointer handling allows the single copy of said given document to be maintained, eliminating the administrative burden of duplicate reporting and file maintenance. Accordingly, this also allows for decreased data storage in systems. Tagging and a search function enables a user or users to navigate through file paths, as well as handle multiple pointers to a single object.

While the present invention may be discussed or focused on a merchandise/inventory industry using for example the food industry for simplicity, the present invention is not limited to any specific (e.g., business) industry. More specifically, the present invention may be applied to any industry, not just a merchandise/inventory industry. For, example, present invention may be applied to the automotive industry where automotive parts are ordered, manufactured, delivered, etc. Accordingly, the present invention may be applied to any industry, not just the food industry as illustrated herewith.

In at least one embodiment of the present disclosure, natural language processing (e.g., 104) may be used to parse the information from these documents (pdf, text files, word, etc.), and store the information in a higher-level data structure (e.g., 190), with the ability to edit such information directly. This is made easier by defined sets of information in food such as specification sheets, ingredient lists, nutrition information, risk data (food spoilage risks, e.g., if not stored at certain temperatures; handling cautions, e.g., not to be transported at speeds higher than 20 miles an hour; etc.), etc. According to at least one embodiment, this then allows suggestions of tags based on the content of the document and/or information matching. As a result, information can be grouped in different contexts without duplication, and then a set of information can be dynamically constructed upon request by a receiver. Essentially this eliminates the need for a single use vendor portal which provide significant benefits over the current systems currently in place.

In at least one embodiment of the present disclosure, blockchain and zero knowledge proofs may be included to allow a user(s) to validate information while protecting sensitive information. Used together, blockchain and zero knowledge proofs provide at least a two-part complimentary system. The blockchain records provide an auditable trail to verify records. Private IDs assigned to a certifier or an auditor may be used to create a digital seal of authenticity for certificates. This may therefore eliminate fraudulent certifications, as entities can check the validity of certifications more easily. The system/method may develop and implement the encryption on behalf of the certifier, although a user can follow a series of steps if they own the document (and/or have an assigned control over the document) in order to verify the validity of the certification. More specifically, a proof is developed. This proof may be for example either a public or encrypted smart contract, or a zero-knowledge proof or a zero-knowledge protocol (ZKP). A ZKP is one in which a prover proves they know the answer to a question without leaking information about the question and is implemented in protocols such as ZCash (ZCash is, for example, a cryptocurrency aimed at using cryptography to provide enhanced privacy for its users compared to other cryptocurrencies such as Bitcoin). The system's implementation is primarily for second degree or n degree (n is greater than 1) validation in which the owner of the document's identity is protected, a public third party has signed off on the authenticity of the document and another entity has ownership of the document to send to a fourth party—in the case of long supply chains.

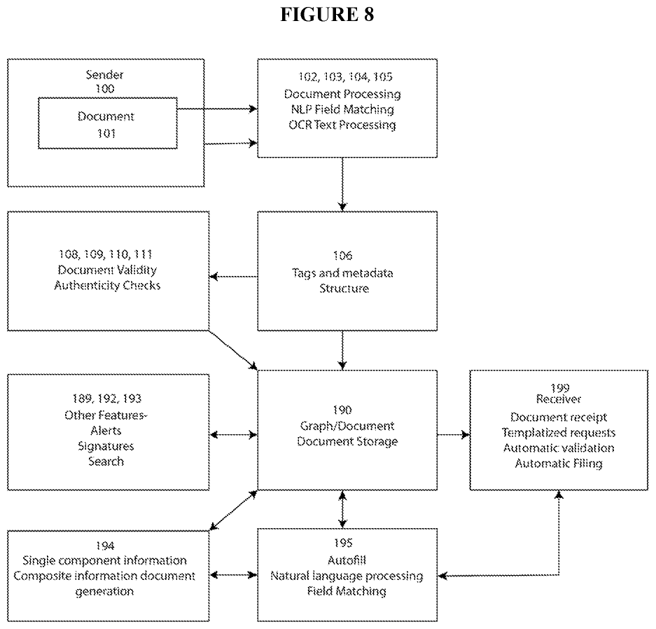

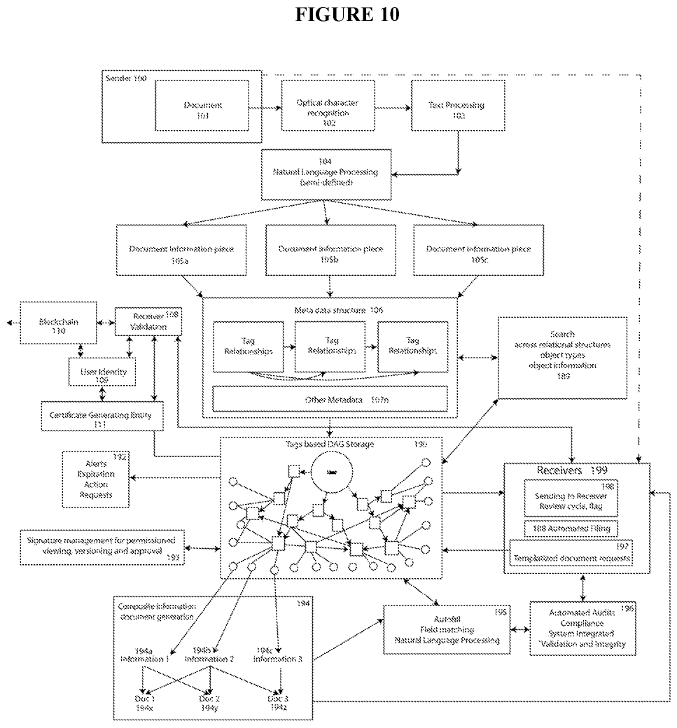

FIG. 8 is a flow diagram/system schematic of the platform of the system designed for documentation and certification in, for example, merchandise (e.g. food) systems. As will be discussed in detail herein (e.g., in regards FIG. 10), the sender 100 communicates the document 101 to the document processing, NLP Field matching and OCR Text processing (102, 103, 104, and 105). As stated below, this part of the process (102-105) is optional (in part or in its entirety) and the process may go directly to the meta data structures 106 (as illustrated by the dashed line in FIG. 10). The processes performed by 102, 103, 104 and 105 may be performed in parallel or in serially in any order or a combination of both parallel and serial.

As will be discussed in detail herein (e.g., in regards FIG. 10), the meta data structures 106 may pass the information to the Document Validity Authentic Checks (108-111).

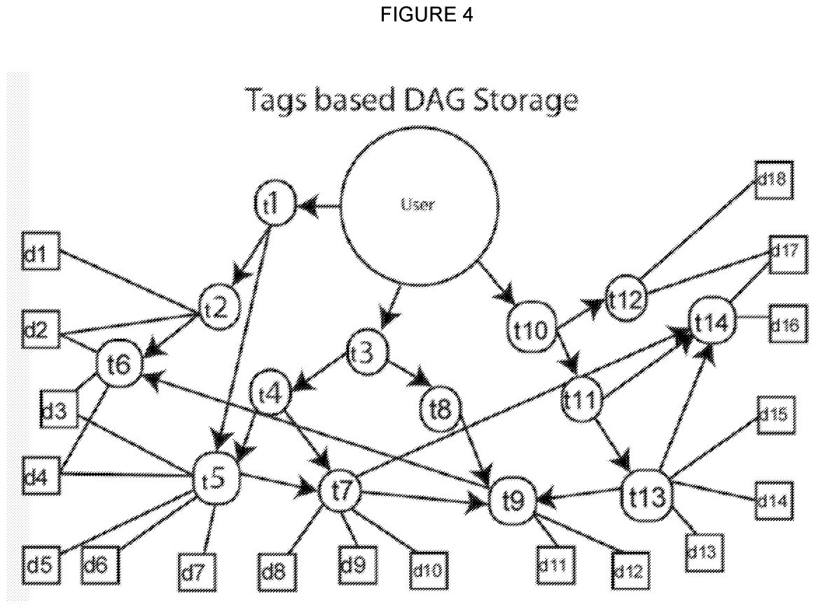

As will be discussed in detail herein (e.g., in regards FIG. 10), the meta data structures 106 and the Document Validity Authentic Checks (108-111) both pass their output information to the Graph/Document Storage Database 190. The meta data structure 106 serves as tags used within the graph (of FIG. 4) which act as nodes for traversal through the graph. The outputs of the permissioning checks 108-111 are specific signatures and truth values that get associated with specific object instances, or with specific edges between objects in the case of permissioning.

As will be discussed in detail herein (e.g., in regards FIG. 10), the Graph/Document Storage Database 190 outputs its information to the receiver 199. As will be discussed in detail herein (e.g., in regards FIG. 10), the Graph/Document Storage Database 190 also communicates back and forth with i) other components/systems/features like alert and notification feature, signature system, etc. (189, 192, 193) ii) information management 194, iii) autofill 195, and iv) the receiver 199.

As will be discussed in detail herein (e.g., in regards FIG. 10), the information management 194 communicates back and forth with autofill 195. Specifically, individual pieces of information 194a-196c can be called or collected by the autofill to dynamically generate a document with the requisite information.

As will be discussed in detail herein (e.g., in regards FIG. 10), the autofill 195 communicates back and forth with the receiver 199. The autofill matches receiver requirements which may be syntactically different between entities but largely require the same set of information.

FIG. 10 illustrates a flow diagram/system schematic of the platform of the system designed for documentation and certification in merchandise (e.g. food) systems according to at least one embodiment.

FIG. 10 provides an example of a specific technical implementation of the various components disclosed herewith. One goal of the system/method (platform) is to more efficiently and/or more quickly manage documents and certificates for supply chains. This system/method is applicable to any supply chain case, but for ease of disclosure, a food supply chain is used as an example. The tag-based document system can be used in any file management system. The external document collection and management serves a particular use case in supply chains for supplier document management, but the concepts may also be implemented in other areas. The specific examples provided herewith and corresponding to examples depicted as in the Figures (FIG. 8, FIG. 10, etc.) are merely examples and those having ordinary skill in the art will recognize other configurations, management, and/or the like that may be used for the same purpose without departing from the scope of the present disclosure.

The conditions for the ecosystem are centered around peer to peer information transfer events, in which there is at least a sender 100 and at least a receiver 199. Sender 100 and receiver 199 may be two separate entities. In most cases the owner of the document and the creator of the document is the same entity as the sender 100. However, in other applications, there may be a third-party entity which grants/assigns a document to an entity that owns the document (or the owner of the document grants/assigns the ownership/control rights to a third-party entity, or etc.), which is then sent to a receiver 199. Also, this example may include the case in which a receiver 199 may send a received document to another entity, creating a permissioned chain of length n. Additionally, a method is disclosed for the management of documents internally within an organization or entity, without the requirement of a receiving entity.

In at least one embodiment, the process begins with a document 101 that an entity, the user (e.g., sender 100), already has in their possession (on their work computer, and/or on the business server, and/or etc.). Document 101 here may be, for example, a data structure that stores all of the information in a single entity or computer science object and document 101 may not be restricted to being a conventional document. For example, document 101 may be a text document, a pdf document, an image spreadsheet or other finite bounded form of data not spread across multiple objects. The distinction is that document 101 does not have to be a set of separate files or images or pieces of data. The metadata and the file are together considered a single document as an atomic unit. In at least one embodiment of deployment, document 101 is stored immediately in the meta data structure shown by 106, bypassing 102-105, but in another embodiment of deployment/implementation, the solid line process is followed to break the document into composite pieces, each forming their own “documents,” associating each resultant document with each other. In addition, according to another embodiment a sender 100 may send documents using both methods of deployment (dashed and solid lines) or a combination thereof.

In regards to at least FIG. 10, an example is provided for a specification sheet of a 6 oz jar of mayonnaise and associated documents for the specification sheet of the 6 oz jar of mayonnaise. It is noted that this process is extendable to any and all other product, not just to mayonnaise. While a specification sheet (spec sheet) would vary by the company producing the document (document 101), at least most spec sheets would generally contain information about the product (e.g., the 6 oz jar of mayonnaise. For example, the information about the product would include (but not limited to) weight of the product and/or package, volume of the product and/or package, packaging details, ingredients of the product, hazards regarding the product and/or package, etc., and the information about the product may also include additional information such as nutrition and/or sustainability information, etc. Accordingly, the process of breaking a document (document 101) into its composing pieces may be the first stage according to at least one embodiment. This first stage connects OCR technology and NLP in order to recognize and break apart documents into their pieces.

After the sender 100 transmits the document 100, the process may begin by using optical character recognition (102) in the case of receiving a non-text pdf, scanned image of a document or image. More specifically, when receiving a document from a sender 100, the system may determine (e.g., scans/evaluates) the document type and when document 101 is determined (or the system is notified of the document type via the sender 100) to be a non-text pdf, scanned image of a document or image, the optical character recognition (102) may perform an optical character recognition on document 101. After preforming optical character recognition (102) on the received document 100, the optical character recognition unit/circuit (102) outputs OCR data to the text processing unit/circuit (103). The optical character recognition (102) may also (or alternatively) output the OCR results directly to the language processing (104) and/or the meta data structures (106).

Text processing (103) may be used to define the fields produced by the text in a document (text being provided via the output of the OCR (102) and/or directly received from the sender 100). When the text processing unit/circuit (103) receives text data, text processing is performed to generate a set of attribute fields, for example the expiration date of the document, document type, or name of document, etc. More specifically, when receiving a document from a sender 100 and/or receiving OCR results from the OCR 102, the text processing unit/circuit (103) processes the received data to extract data representing the set of attribute fields. After preforming the text processing (103) on the received document 100 and/or received OCR data, the text processing unit/circuit (103) outputs a set of attribute fields to the language processing (104). The text processing unit/circuit (103) may also (or alternatively) output results directly to the meta data structures (106).

The language processing (104) may be used to determine the type of document e.g. a specification sheet, a certificate, a packing list and then to match fields in the general document type to the information in the document. This field mapping is stored in a defined data structure. The process is not entirely natural since the information formatting is finitely bounded in possibilities by the document type. The mayo producer (receiver 199) then scans (e.g., OCR 102) the paper document, which is read by the system into its text fields (e.g., text processing 103). These text fields for the oil (parent category/categories) are then identified by their parts (child category/categories) as the ingredient list, the eggs sustainability criteria such as vegetarian fed, the farms contact information and other fields. Hence, the text processing 103 determines a parent category or categories and then further determines child category or categories for each determined parent category.

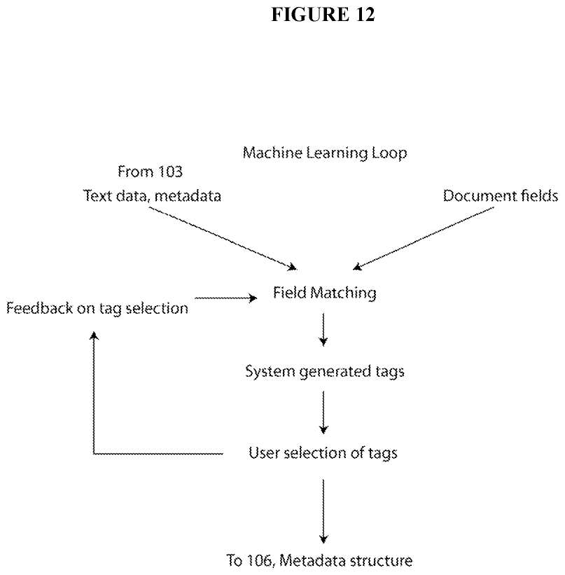

The system over time may learn that such information (document type, fields, category/categories, etc.) likely corresponds to a specification sheet and automatically tags the document with the category. While this is an automated procedure, the automatic tagging may be reviewed by a user (e.g., sender 100 or another user). Machine learning (e.g., FIG. 12) is achieved by using user defined document categories and field matching as the training set to understand what types of information fields comprise a specific type of document. Accordingly, the system may be preloaded and/or loaded with a set of pre-existing tags, categories, etc. to make the automatic tagging more accurate and/or more efficient. Also, with the use of preloaded and/or loaded with a set of pre-existing tags, categories, etc., a user(s) of a specific industry, a new product on the market, etc. may for example make the process more quickly adaptable with automatic tagging. Furthermore, if many instances of documents have an ingredient list, a list of hazards, a listing of SKUs, weight and volume data and are assigned in the spec sheet, the system can learn that a new document with similar fields is likely to be a spec sheet (e.g., labeling a received document as a spec sheet). The information in each of those fields is then mapped to an information piece as part of the data structure, for example the ingredients for the oil would be assigned canola, rapeseed, and the farm information stored with the farm value. As such the document is now broken into individual pieces (105a, 105b, 105c, . . . 105n) that comprise the overall document. More specifically, canola being assigned to 105a, rapeseed being assigned to 105b, etc. These pieces form an automatically generated set of tags which can be associated with the document, e.g. mayo, egg allergen, spec sheet. As stated above, this part of the process is optional, and the process may go directly to the meta data structures (106).

Rather than using a hierarchical folder-based structure, the system implements a tag-based document management system without the need to have any folders for organization. Tag-based document management will greatly improve organizational efficiency, retrieval time, collaboration and document management for use of the system. Traditional hierarchical folder systems require that documents be placed in only one location. However, many documents often need to be used in different contexts. For example, a specification of an ingredient may correspond to multiple products, a supplier or the ingredient itself. File hierarchies force the user to pick one of the relevant categories to place the document in. If a user wants to place a file into multiple directories, they must either make duplicate copies, in which case the user must manage versions and remember all locations of the file, or create shortcuts to the file which is labor intensive as each path must be selected. Further, folders often have duplicate subfolders due to artificial hierarchy constraints in which folders have duplicate substructure, e.g. yearly folders that are subdivided the same way each year. As a result, a user often must dig through multiple folders to reach all the relevant documents for a given working context.

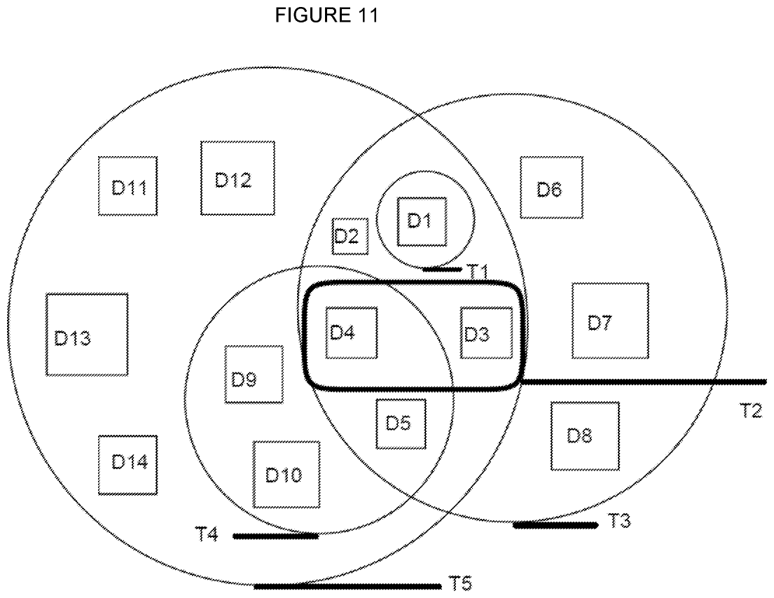

In some regards, hierarchical tag-based systems may be said to act similarly to tree-based folder structures in that tags can have subtags the way that folders have subfolders, creating parent and child relationships. Tag systems that do exist are generally tree based as well. However, the functionality of tree-based systems are expanded by implementing a graph structure, specifically a directed acyclic graph (DAG) as illustrated in at least FIG. 4 and 190 of FIG. 10. A graph is a data structure composed of nodes and edges, in which edges link and establish relationships between nodes. In other words, a node is a piece of data (e.g., a tag or a document) and an edge is the relationship linking two pieces of information (linking two nodes). A directed acyclic graph means that the edges are one directional, and that no cycles can be formed between nodes, i.e., by following a path of logically consistent directional edges the same node cannot be revisited. The implementation as a graph means that a given tag may have multiple parents, rather than being restricted to a single parent as in hierarchical tree structures. The result is essentially equivalent to placing a folder in multiple different locations, resulting in the ability to create multiple virtual paths to the same directory. The result of imposing the restriction of direction and acyclic is that for a given tag, one of its child tags cannot also be a parent of the tag, which is essential in order to filter documents. This model can be conceptualized as Venn diagrams in multidimensional space as illustrated in FIG. 11, where spheroid shapes are the tags, containing documents. Multiple spheroid shapes may intersect or be wholly contained within another. Using the sphere model, a circle contained within another (a child tag) cannot also encompass the entirety of the circle it is contained within (the parent tag), unless they are the same circle, and therefore a child tag narrows the results of a query. The acyclic restriction ensures that a child tag is not larger than its parent, which would create an infinite loop, and can be checked by checking a flattened list of children whenever a parent is added. In order words, the system/method can restrict a child tag from being assigned to any tag that has any linear parentage which includes itself (the restriction may also be accompanied by an error message/notification to the user). For example, T3 cannot be given a child tag to either T5 nor T4 if T3 is the parent of T5 and T5 is the parent of T4. Similarly, the system/method can restrict a parent tag to be assigned to any tag that has any linear children relationship that includes itself (the restriction may also be accompanied by an error message/notification to the user). For example, T4 cannot be given a parent tag to either T5 nor T4 if T3 is the parent of T5 and T5 is the parent of T4.

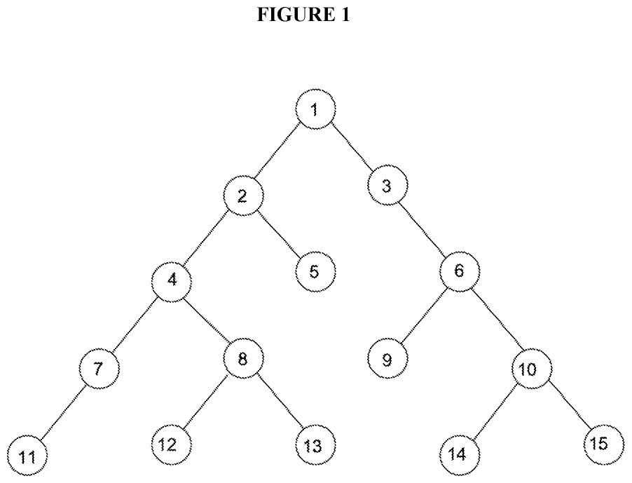

FIGS. 1-3 demonstrate illustrations of various tree or graph-based structures for explanation of the technical differences/similarities between implementation of the structures. In these illustrations of FIGS. 1-3, all lines are unidirectional, pointing downward to be an acyclic structure. If the lines were bidirectional, they would represent a cyclic structure.

FIG. 1 is an illustration of a standard document tree structure, which models how folders work in standard file systems. Each circle may be a folder, which can have multiple children, but all relationships are directed, and each folder can only have one parent.

For example, in FIG. 1, node 1 would be a parent folder while nodes 2 and 3 are child folders to parent folder 1. Similarly, node 2 would be a parent folder while nodes 4 and 5 are child folders to parent folder 2.

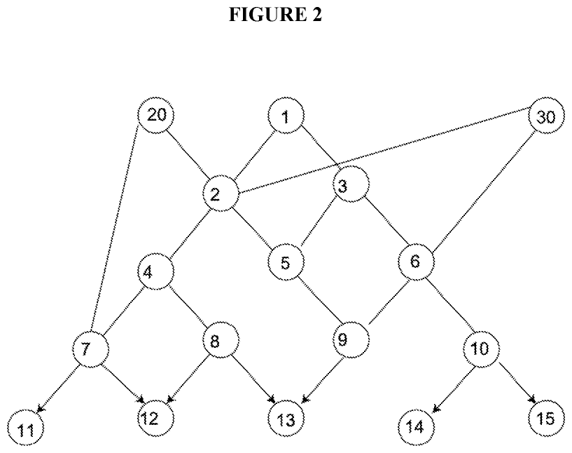

FIG. 2 is an illustration of a directed acyclic structure according to at least one embodiment. In this, each tag (circle) can have one or more parents, allowing a user to navigate to the same location by starting at two different areas.

For example, in FIG. 2, node 1 would be a parent folder while nodes 2 and 3 are child folders to parent folder 1. However, in FIG. 2, node 30 and node 20 are also parents of node 2, resulting in node 2 having 3 parents. Node 2 is therefore reachable from node 1, 20 and/or 30. Hence, in this example, a user can navigate to the same location (e.g., child node 2) by starting in any of three different areas/locations (e.g., parent node 2, parent node 20, and/or parent node 30).

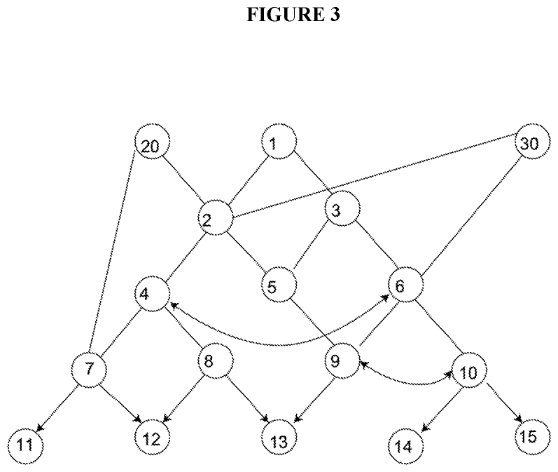

FIG. 3 is an illustration of a cyclic structure according to at least one embodiment. Since the arrows are bidirectional, implemented as the circles whose endpoints are the arrows are parents of each other, they form the smallest cycle possible—a cycle of two items. The system does not allow the formation of cycles in relationships.

FIG. 4 is an illustration of a directed acyclic structure according to at least one embodiment, implementing the directed acyclic graph into the tags-based document management system rather than folders. With the exception of the circle representing the user, all other circles in FIG. 4 represent tags. In FIG. 4, the squares represent the documents. The documents representing endpoints in the search process. To find documents via a search using tag(s), the User may select one tag or multiple tags until the desire document(s) is/are found/located.

In at least one embodiment, the User can be presented with only the available parent tags in the system (t1, t3, and t10). The user can then select any child tag(s). For example, if the user is presented with only the available parent tags in the system (t1, t3, and t10) and thereby selects t3, the user is then presented with only the direct child tags of t3 which are t4 and t8. Alternatively, when selecting t3, the user may instead be presented with all child and descendant children whereby t4, t5, t7, t8, and t9 are presented. It should be noted that no cyclic relationship of tagging is illustrated in at least FIG. 4 as the system/method can restrict this type of relationship and hence providing only an acyclic relationship of tagging.

In one example, there are three documents d5, d6, and d7 associated with tag 5 (t5). If the user wants to locate one, two or all three of these documents (d5, d6, and d7), the User would have to navigate tags to reach one and/or all of these documents. More specifically, the user can take a first path by selecting tag 3 (t3, e.g., “Certifications/Certified Food Products”), then tag 4 (t4, e.g., “Organic”), then tag 5 (t5, e.g., “Rice”) to be presented with the three documents (d5, d6, and d7). The user may also locate the three documents (d5, d6, and d7), by first selecting tag 1 (t1, e.g., “Plant Food Products”) then tag 5 (t5, e.g., “Rice”).

In at least one embodiment, the User can be presented with all available tags in the system (t1, t2, t3, . . . t14, . . . tn). The user can then enter “Organic” in the search and be brought to tag 4, t4 (“Organic”), skipping t3. Then, being at tag 4's location, the user can select the parent tag t3 or the child tags t5 and t7.

It should be note that the system tagging can be set up in any manner desirable for the system owner. In at least one embodiment, all users can tag documents (and all user benefit from each other tags) and any users can do a search via all tags but each user sets their own parent tags. In addition, the system may allow only system administrators to pre-store all available tags so that the system does not get inundated by users entering in similar tags for the (essentially) same tag (e.g., “organic,” “organics,” “organic label,” “organic certification,” “certification organic,” “organic cert,” etc.). Of course, the system is not limited any manner of tagging and may also allow only users to add tags, or a combination of pre-stored tags and user added tags, or etc.

In at least one embodiment, when a user is at t11's location, the user may be presented with all parent and/or all child tags (and/or descendant tags and/or all ancestry/grandparent tags), e.g., by presenting (all) parent tags t10, by presenting direct child tags t13 and t14, all children tags t13, t14, and t9, and/or etc.

Furthermore, the user can select and/or be presented to select any or all combinations of lineal descendant parents (like grand grandparent(s), great grandparent(s), etc.), parent(s), direct child(s), descendant child(ren), etc.). For example, the user could select t10 and select all child and descendant tags to be presented whereby t9, t11, t12, t13, t14, and t9 are presented. Alternatively, the user could select t11 and only all direct child tags to be presented whereby only t13 and t14 are presented.

Similarly, the user may be presented with a search feature (to search all available tags, all parent tags, all child tags, all intermediate tags, etc.) to enter a tag(s) (e.g., “Organic” OR “Organic” and “California”) start at any tag 8 (t8). In addition, the user may search for tags that have been assigned by a particular user or company.

FIG. 11 is at least one embodiment illustrating a spheroid procedure for tag-based document filtering. This model can be conceptualized as Venn diagrams in multidimensional space. In FIG. 11, each spheroid (circle) shape represents a tag and each square (or rectangular) shape represent a document. Accordingly, a circle containing a square represents a document that is tagged (or a tagged document). As illustrated in FIG. 11, multiple spheroid shapes may intersect or be wholly contained within another. In addition, one or a plurality of square shapes (documents) may be contained in one or more circle shapes.

Using this sphere model, a (smaller) circle that is contained within another (larger) circle represents a child tag, and hence the other (larger) circle represents the parent tag of the child tag. The child tag (or a circle contained within another circle) cannot also encompass the entirety of the (larger) circle it is contained within (the parent tag), unless they are the same circle, and therefore a child tag narrows the results of a query. Accordingly, in FIG. 11, a large circle (e.g., T3 or T5) represents a parent tag while a smaller circle (e.g., T1) represents a child tag. Hence, with this use of this method of tagging, a cyclic tag graphing structure is restricted and instead provides an acyclic tag graphing structure.

As illustrated in FIG. 11, there are 14 total documents (D1 to D14). The document D1 is tagged with a tag represented by tag T1. Documents D3 and D4 are tagged with a tag represented by tag T2. Documents D1, D2, D3, D4, D5, D6, D7 and D8 are all tagged with a tag represented by tag T3. Accordingly, tag T1 is a (first) child tag and tag T2 is a (second) child tag whereby tag T3 is a parent tag of at least the documents tagged with T1 and T2. Accordingly, D1 and the combination of D3 and D4 are both and individually child documents of parent tag T3.

According to at least FIG. 11, a user can start a search by using for example T3 which results in documents D1, D2, D3, D4, D5, D6, D7 and D8. The user can then select the additional tag of T4 which results in only documents D4 and D5 being presented to the user. The User can select either or both documents D4 and D5, or the user may select the additional tag of T2 and be provided with a result of only document D4.

The graph/document oriented structure for the database 190 comprises a format for data organization. It should be noted that the Tags based DAG Storage 190 of FIG. 10 is illustrated in FIG. 4. In 190, the squares represent documents and the circles represent tags. Typical document file trees are directional, linear one to one mapping, which restricts the ability to have information in multiple locations without copying the same document over and over again. This graph system according to the embodiments disclosed herein allows multiple “filepaths” to point to the same location through tags, which allows a user to reach a specific piece of information from multiple different angles, essentially similar to creating multiple shortcuts to a given set of documents. This is achieved through a user defining a directed hierarchical organizational graph structure to organize the “paths” and then traversing the constructed graph.

For example, someone in a manufacturing company (e.g., a first user at a first location) may want to reach the mayo information (of the 6 oz jar of mayo) by the manufacturing site (e.g., tag 1 (tg1) being related to a location), while someone else (e.g., a second user being at a second location) in the product department of a company may want to reach the (same) mayo information by the 6 oz sku (e.g., a second tag t2), while a third person (e.g., a third user at the second location) in the quality of the same company may want to reach the (same) mayo information from ingredient suppliers (e.g., a third tag t3) and ingredients (e.g., a fourth tag t4). Each of these virtual paths forms a tag, creating a different way to retrieve the same document.

Another example is to have two simultaneous organization of the same information. For example in the case of organic certifications, a user may want to define (or select) the path based on certificate(s) (a first criteria—food having different certifications like organic certification, all natural certification, organic and all natural certification(s), etc.), then define (or select) the certificate type(s) (a second criteria which may be more narrowing than the first criteria—organic, all natural, organic and all natural, etc.). In a hierarchical folder-based structure, once the folder for “organic” is selected or found, the organic folder is presented/displayed to the user. Accordingly, in the organic folder, there may be individual folders for suppliers (and may be additional folders for other items like manufactures, locations, etc.), or alternatively have the filepath (pointers) sorted by supplier, then certificates, then the certificate type, then the organic certificate. Conventional systems require duplicate copies of information at the end of both filepaths. In contrast, this system allows simultaneous existence of both such file paths connected to a single instance through tags, such that changes to the instance of information affects only the instance itself, not the filepaths. Therefore, the user only has to worry about changing the content and does not have to manage duplicate copies or version control across copies created for use in other purposes. The filepaths implemented in the disclosure are not explicit filepaths as in conventional computer systems, e.g. “C://UserName/Documents/ExampleFolder/.” Instead, sorting is achieved through the creating of virtual paths through combinations of tags as described in this disclosure.

Negative filtering may also be used, in which the user selects two or more tags (tags X and Y), and excludes any documents which are tagged with a given (tag T). For example, referring to FIG. 11, a user may select tags T3 and T5 which would result in documents D1, D2, D3, D4 and D5. However, if the user selects tags T3 and T5 but actively excludes tag T4, then the search result would be documents D1, D2 and D3 (whereby documents D4 and D5 are removed from the document (or folder) display to the user).

Multidimensional filtering allows tag-based file systems to solve artificial hierarchical relationships, as well as eliminate duplication between folders, further expanding the capabilities possible in tree-based folder structures. In standard file hierarchies, a user is often forced to make hierarchical decisions between unrelated concepts. For example, a user may first choose to have their certifications folder split by type of certification, and then within each certification type folder, may split it by supplier name. Thus, supplier names are made subordinate to certification type, even though they are unrelated concepts. This process must then be repeated in each other certification type folder, creating duplicate work and the use of unnecessary storage space on the system. In contrast, hierarchical tags are additive, meaning the hierarchy is established once, for example in a situation where a certifications parent tag has different certifications types as child tags, and a separate supplier tag has supplier names as subtags. Each hierarchy is only created once, and then the tags can be added together to form the union of two or more sets. For example, a user can select the Supplier A tag and also the Ingredient B tag and find the documents that form the intersection of the sets. The positive difference of two sets can also be found, or any other combination of filters (exclusion, disjoint sets, etc.).

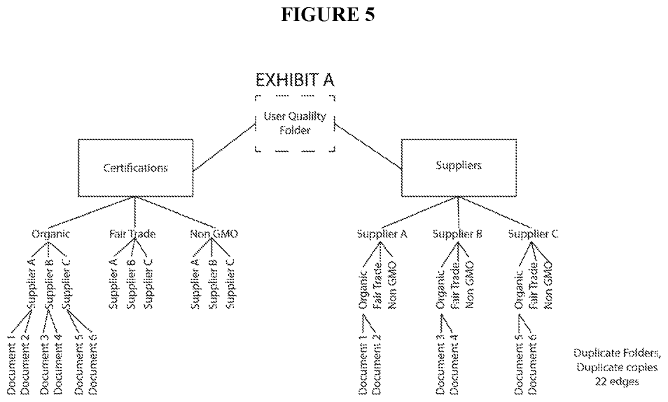

FIGS. 5, 6 and 7 provide comparative examples of document systems for storing organic certificates according to one or more embodiments. While there may be numerous documents, file structures, etc.; only the file structures for specifically organic documents are shown for illustration purposes (other documents are hidden for simplicity).

FIG. 5 demonstrates the requirements of a standard document storage using tree-based folder structures if information is to be stored in two different paths. Standard storage requires that duplicate folders be made in order to accommodate multiple file paths. Further, duplicate copies must be made as end points, and in order to update the information both copies must be changed and maintained separately. As a result, most users never implement a full system since the maintenance workload is high, leading to lost files, and single purpose file structures, as the structure desired for an audit does not match the structure used in production. Shortcuts in standard file trees are labor intensive to make and maintain, and only redirect paths without allowing for possible regroupings of documents, in the crudest implementation.

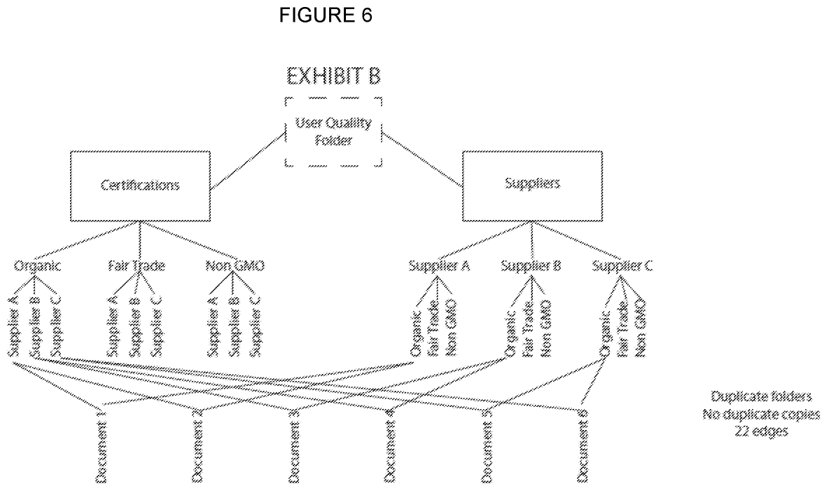

FIG. 6 illustrates a system in which a document can be placed at the end of multiple filepaths, without duplicating the document itself (essentially creating shortcuts to the document). The process structure only handling document paths, the process shows an increase in memory allocation by handling no duplicate copies and instead storing only the same number of pointers to the document compared to the process shown in FIG. 5. Therefore, in order to access Document 1, a user (e.g., User A) may select the Quality Folder then select the Certifications Folder, then the Organic Folder, then Supplier A. Alternatively, the user (the same user (User A) or an entirely different user (e.g., User B)) can navigate to the same exact Document 1 by selecting the Suppliers Folder, then selecting Supplier A folder, then selecting the Organic folder. Since only a single copy of Document 1 is stored, version management is improved since a user can change Document 1 without worrying about maintaining and updating all copies that exist in the system. Hence, when updating, editing, deleting, etc. Document 1, the same updating, editing, deleting, etc. is being performed as it is the same exact Document 1.

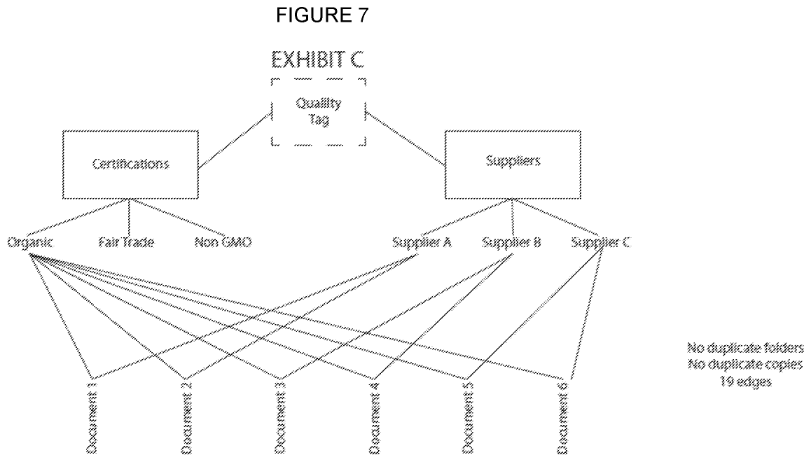

FIG. 7 illustrates a graph based tag structure that may be computationally and spatially less memory intensive (compared to FIGS. 5 and/or 6 which are folder based structures), as embodiments of the implementation requires no duplicate copies, no duplicate folders and uses 19 edges compared to that of the duplicate copy and duplicate folder with 22 edge case, as well as the no duplicate copy but duplicate folders and 22 edge case. Edges (or pointers) are less storage intensive than folders or documents and thus embodiments of this disclosure demonstrate clear advantages in storage memory compared to conventional systems by maintaining only a single copy of a given object (or less copies of a given object). Retrieval is further simplified, as any combination of documents can be retrieved in a single view, whereas in a traditional file system a user must navigate through multiple different folders and structures in order to retrieve each document individually. In this method, a user can select either (option 1) the Certifications (parent) tag, then the Organic (child) tag, and/or (option 2) the user can select the Suppliers (parent) tag and then the Supplier A (child) tag. Through this, the user would retrieve both Document 1 and Document 2 in either (or both) tag search method.

Accordingly, FIG. 7 provides significantly more resource benefits in terms of computational storage over at least FIG. 5, since duplicate files/folders are not created (or needed to be created), while also simplifying the user process and management of document retrieval. Further, with FIG. 7 a user can retrieve all relevant documents (and/or folders) in a single view.

Documents and document information pieces should be the endpoints to be associated with one or more tags (107), for example instances of people, products or locations. In other words, it is preferable to tag the component data (in a system or subsystem with distributers, data like location of distributers, type of product (food, automotive, etc.), and the like should be tagged. Documents often need to be used in different contexts. For example, a manufacturer may use canola oil in producing a type of mayo. The manufacturer may source the oil from multiple different suppliers, and also may use the same oil in multiple different products. As a result, there may be multiple uses for the same set of documents—when looking by supplier, product, for the oil itself, etc. Conventional folder systems require that these documents be placed in a single location and thereby have so much redundant copies of documents. With a tag-based system, all of these tags—the supplier name, the products used in, the oil ingredient, etc. may be applied to the relevant documents and retrieved in a single view based on context. The association with the receiver 199 is generated on permissioning, as discussed in this disclosure. These associations form the basis of the navigation/organization structure. The relationships between tags are user defined in the initial implementation but can be automatically generated in later implementations, or automatically generated from document information as discussed above. For example, if the system has previously associated a hazard analysis and critical control points (HAACP) document about the mayo with the mayo product and a specific manufacturing site, the system may automatically tag the mayo with the manufacturing site without user input. In another embodiment, the user can also manually tag the mayo with the manufacturing site. In yet another embodiment, the user may be prompted to verify in the case where the system automatically tags the mayo with the manufacturing site.

In the user experience, although the relationships are directed, the user is able to technically traverse the graph (e.g., FIG. 4) in both directions, similar to the way in which folders are directional but a user is able to navigate up and down folders. Traversal refers to navigation between tags and documents, for example by clicking and applying a set of tags or selecting a child tag of a currently selected tag. Thus, the relationships are maintained by a DAG but the traversal is through a regular graph which can be cyclic. Breadcrumbs are used to denote the user navigated path to the given directory. However, a distinct characteristic in a DAG implementation is that upwards traversal may have multiple possible parents, so breadcrumbs must be able to support traversal across previously selected tags, as well as allow the user to travel to any of the parents. Traversal may also result in a cycle, which should be handled by the breadcrumbs. In one implementation, no breadcrumbs are recorded and instead the user is allowed to traverse to any parent and any child of a given selected tag. In another implementation, a complete list of breadcrumbs is recorded, and the breadcrumbs are cleared by the user starting over or navigating away from the page. This implementation can result in long lengths of breadcrumbs, especially if a user is browsing through a file system without a clear knowledge of destination. In a third implementation, a complete list of breadcrumbs is recorded, but if a cycle is made between the crumbs then the list of breadcrumbs can either be truncated between the cycle, or before the cycle starts. This allows the user to maintain both a history of traversal as well as reduces the length of the breadcrumb chain. Since multiple tags can be applied and separately traversed, breadcrumbs should be maintained independently for each tag.

It should be noted that a breadcrumb may be a user interface reminder to the user of the method in which they navigate to a given folder view in conventional systems (e.g., the folder path they used). In this tag-based system, this system needs to track the tag path the user used so the user can go Certificate (grandparent, e.g., t1 of FIG. 4) to Organic (parent, e.g., t5 of FIG. 4) to schedule C (child, e.g., t7 of FIG. 4) and then go back up to the Certificate tag (e.g., t1 of FIG. 4) and go from Certificate (grandparent and parent to schedule C) to Fair Trade (child to Certificate, e.g., t2 of FIG. 4).

Compared to existing tree-based tag systems and tree-based folder systems the restriction upon single parentage are not required, creating a graph structure. The graph structure allows a user to create multiple virtual paths to not only each document, but groups of documents. For example, the group of Organic documents may be reached by a parent tag of Certifications, or a parent tag of Product Types, then navigating to the Organic (child) tag. This allows users to quickly organize their documents without needing to manage tags for individual documents if another user has already set the grouping. For example, both marketing and product departments may need access to a Logos set of documents which contains the company's logos. Each document should be tagged Logos, and then the different departments can set their own parent tags for the Logos tag to place the document in a location that makes sense to them. This process can be generally expanded to solve the problem of agreeing upon the proper places to put documents across organizations. Different people organize their documents in different schemas, and contextually understand the organization in different ways. The structure defined by one individual may not make sense to another individual who shares that document, often leading to cases in which someone complains that they know a document exists but cannot find it. In the most extreme case, each user can create their own tag, sort documents through a hierarchical graph in a way that makes sense to them, without affecting the others organization, but changes to the document are propagated to both users.

One limitation to DAG systems may be said that visualizations are often quite complex and difficult to navigate, as typically topological “levels” do not exist in graph systems. For example, a folder's depth can be counted by its distance from the root node, but a given node in a graph may have one parent of distance 2 (nodes) from the root and another of distance 8 (nodes). For example, in FIG. 4, t5 has a first distance option of 2 nodes (user to t1 and then t1 to t5) and also has a second distance option of 3 nodes (user to t3, and then t3 to t4 and then t4 to t5). Further, a node may have multiple parents and multiple children, and each parent and child may also have multiple other parents and children. The complexity increases as in a multidimensional filtering scenario, the user may have multiple unrelated active tags.

In at least one embodiment, the system displays solely the active tags and allows the user to traverse the structure by expanding parents or children of individual tags as needed. Active tags are the tags the user has currently selected, as opposed to tags that are in the repository of tags corresponding to an organization. Users may find this method preferable as users can either directly navigate to a tag or browse in one direction. However, in managing relationships it is important to know the existing relationships of given tags in order to manage, create and/or delete relationships between tags. In such a situation, the application renders the ancestral hierarchy of all selected active tags, with the terminal note being the selected active tags (no children nodes are shown), connecting the relationships where appropriate. The user then selects tag(s) out of the currently shown tags, rendering their complete hierarchy, in order to further manage relationships through a drag and drop functionality. The converse can also be implemented in which the active tags are the root nodes, and the child hierarchy only is shown. Alternatively, a distance of n levels can be shown around the active tag (the value of “n” can be selected by the user and/or the system). These implementations primarily conserve space and reduce the number of elements a user must interact with and process. In one implementation, when a user retrieves documents, only documents that are directly tagged with the applied active tags are retrieved and returned for the user. In another implementation, when a user retrieves documents, all documents which correspond to descendants (children tags) of the currently applied active tags are also retrieved.

Data stored in the database can be additionally validated through blockchain and user identity as shown in units 108-111. The creation of digital signatures based on a unique digital identity to prove the authenticity of a granted certificate are typically limited to isolated solutions. At most, some other competitor systems might be able handle only the signing and authentication, but those other competitor systems do not handle signing and authentication along with managing storage or transfer. As a result of some of the other competitor systems, validating information is labor intensive as a user may need to go to various locations in order to manage the information. The system herein integrates with blockchain technology in order to prove ownership of information, proper permissioning and data validity, etc.

While the disclosure provides numerous examples and may be used in numerous different methods, in most general cases, a user has a unique id. When a document or document information piece is posted to the system, a hash of that information is generated using methods like SHA-256. A hash generates a thumbprint of a piece of data to uniquely identify a piece of information. At any future point, a hash can be generated and then be compared to previously generated hashes to prove that a set of data has not been changed. For example, a pdf can be hashed to generate a string like “kASFijoufEADKvlogw3euvAlk213t80eSD” which uniquely identifies the data inside of that pdf. These hashes are aggregated in a Merkle tree, which is passed to a blockchain 110 for record to achieve immutability, returning a block record back to the system. The receiver 199 can then validate the authenticity of the data by first performing their own hash of the document they receive, and then comparing the generated hash with the hash tree and the hash recorded in the block, represented by 108. In the case where a certifier 111 granting documents to a certificate recipient (sender 100), both the certifying agency's 111 and the certificate recipient (sender 100) identity are recorded and hashed, then the transaction of the granting of the document from the agency to the recipient is also hashed 111. The system then creates a permissioning trail of documents as the sender 100 proceeds to send the document to the customers 199, guaranteeing integrity as the receiver 199 can also perform validation 108. For example, an organic body 111 may certify the mayo producer 100 as organic, and a record containing a hash of the mayo producer and certifying body's ids and the transaction granting the mayo producer the certificate (document 101). The act of sending the document 198 to a receiver 199 can then also be recorded, creating a chain of custody. This information is then stored with the document or the document part. In contrast to existing systems of blockchain validated documents, the system posts the hash of the document to the ledger system on the users behalf rather than involving the user in the act of sending the information to the blockchain 110, allowing the complexities of blockchain management to be abstracted away from the user. As a result, the user has only to transfer documents through this system, and this system acts as a “middleman” for verification as the significant information involved in the transaction is that the hash matches the document in question, not the submitter of the hash to the blockchain. The user can independently prove the integrity of the system's record in a simpler form by hashing the document themselves.

As illustrated in at least FIGS. 8 and 10, the system may also provide an alert and notification feature 192 which may automatically generate alerts based off of conditional triggers such as days until document expiration, and/or document rejection by a receiver 199, and/or etc. Further, in the instance where a document(s) is/are read and broken into individual pieces custom alerts can be triggered off of conditional information in the document(s). For example, if a certificate of authenticity is sent with product parameters, e.g. weight, volume, microbial load, that are out of acceptable quality control thresholds (or do not meet a certain criteria(s)) like a microbial count that is out of bounds, or product with insufficient weight, etc., the system can reject the document and return a notification to each party that a sent document that was rejected for the reasons in the quality control threshold. Such a system can then be used to automate the quality management and document review process after sufficient training data is gathered. Another embodiment is in document expiration, which may notify the user that a document is expiring a user defined number of days (or hours, or minutes, etc.) before expiration, and/or upon expiration.

This system may also implement a search 189 across any or all attribute field(s) of an object(s), such as expiration date, identification (ID), name of the document, a term(s) in a document, filetype, or notes as well as a relational search across tag(s) established in the system. Users can traverse the graph structure by searching and/or traversing through the tag relationships, browsing up and down into a tag's parents or children. For example, a user may search by expiration date (an attribute field of a document), or search for tagged locations associated with the 6 oz mayo, or etc. The search 189 may be performed directly with the tag based storage system 190 and/or the meta data structure 106.

Receivers 199 may also templatize document requests to send to a vendor (sender 100), and undergo a human monitored acceptance and rejection cycle 198, implemented on a specific information piece level, instead of going through email and manually pointing at erroneous pieces.

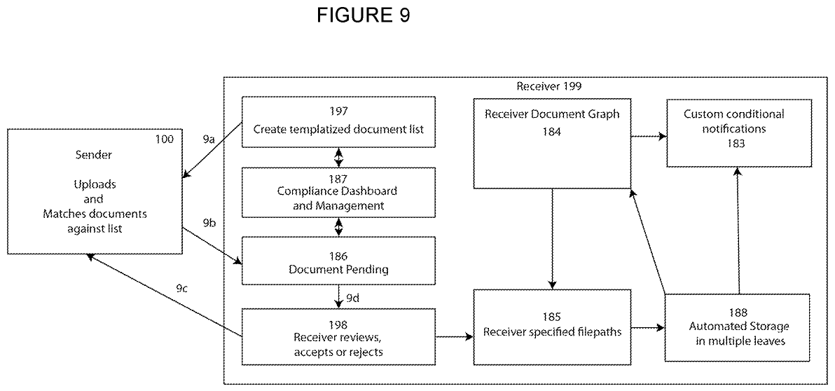

FIG. 9 illustrates at least one embodiment for a receiving process in the system. The receiver 199 creates/generates a templatized list of document types 197 as a form for a sender 100 to upload a document(s). The receiver 199/receiver system sends the templatized list of document types 197 to a sender 100 in 9a. Based on receiving the templatized list of document types 197 from the receiver, the sender 100 uploads the document(s) in 9b. The uploaded document(s) (e.g., document 101) then is placed in a pending status for review 186 (e.g., by human review (can be the receiver user or another user). The receiver 199 can send a notification to the receiver in 9d that a new document has been received/uploaded (by the sender 100), then the receiver 199 may accept or reject the document 101 (or may accept and/or reject each document(s) when multiple documents are received). The receiver 199/receiver system sends the acceptance and/or rejection to a sender 100 in 9c based on the receiver's decision(s) in 198.

Document request templates may be used as one mechanism for collecting and categorizing data, similar to a form. A user can define a set of documents and/or information that the user may require and/or desire from a sender (e.g., sender 100), such as a specification sheet, a HAACP plan, a HAACP flowsheet, etc. The template is then sent to a sender (9a) to fill out. Typically, results for a form in other competitor systems are at most constrained to the directory that the form is stored, as for example in Google forms. Alternatively, a single form may allow a user (e.g., receiver 199) to store all responses received in a different location, and/or specify the location on a per request basis. Another embodiment may allow a user to store each line item in a separate location, but current implementations of competitor systems fail to allow users to both store all the documents in different places on a per request basis, at the granularity of individual line items without adding high amounts of complexity. The system herein may allow a user to specify where a document(s) should be stored in a tag-based filing system with multiple possible locations for each file on a per file basis without duplication and minimizing user input, allowing documents to be automatically filed.

In at least one embodiment, a user (e.g., receiver 199) may define a number of document slots for a template (the number of slots being 1 or more). Each document slot defines a different document to be received in the template. For example, the first slot may be an Organic Certificate (being associated with the first Document that will be received) while the second slot may be the Ingredient List (being associated with the second Document that will be received). One or more documents may be sent in response to each document slot. The present disclosure provides numerous benefits, for example, when a user requests the same set of documents from other people on a recurring basis, the user can make a template whereby the user may also pre-tag their templates so documents received through the template will be automatically tagged.

In at least one embodiment, all documents received through this template structure may be automatically tagged with the name of the template and the tags. Accordingly, each slot can be a term or a plurality of terms (a sentence, a statement, etc.) that defines (or instructs) what the recipient is being requested to send. For example, the user can label a slot as “Ingredient List” which would prompt the recipient to send the Document that is an Ingredient List for the desired product. In addition to the document slot having the label, the document slot can also include one or more documents to be sent along with the transmitted template group. For example, a fill in the blank document (like a survey) may be included in the document slot so that the recipient will complete and send back that form instead of or in addition to a document corresponding to the request.

The totality of these slots form a template group whereby one slot can form a template group if there are a total of one slot generate (and sent) by the user. After creation of the template group, the user may define (assign) a tag and/or a set of tags to apply to any and all documents (or a combination of document sets) received through the template (and prior to transmitting the template group). After the tags to be applied are defined, the user can further define tags which are applied to each individual template slot.

In at least one embodiment, the user can define/assign tag(s) after creating the template group in three types (or levels) of assignments.

The first type of tag assignment is a tag(s) assigned to each, some and/or all of the document slots that will be sent whereby these tag(s) will be automatically assigned to the documents received in association with the document slots. In other words, the user may use the first level of tagging so that each slot may automatically be tagged with the user's assignment (which for example is the user's selected label or name given to that particular slot—e.g., an assignment (or label) of FOOD would be used as a tag of FOOD) by a conversion (conversion of a label to a tag) when a document(s) are received in conjugation with that particular slot(s).

The second type of tag assignment is a tag(s) assigned to a specific slot (or slots) that is selected by the user who created the slot(s) whereby these tag(s) will be automatically assigned to the documents received in association with the selected document slots. In other words, the user may use the second level of tagging is a direct tagging method for a tag to be automatically applied to a particular slot(s).

The third type of tag assignment is a tag(s) assigned to the selected recipients (selected by the user) that will receive the transmitted template slot(s) based on the user selecting the recipient(s) and then instructing the system to send the selected template slot(s) to the selected recipient(s). In other words, the user may use the third level of tagging to send a prepared template (e.g., a template that has three prepared template slots for food vendors) to a first vendor (e.g., a nut vendor) with a first tag (tag=NUT) and also send the same exact prepared template to a second vendor (e.g., a milk vendor) with a second different tag (tag=MILK). Thereby, with the third level of tagging, the first recipient (e.g., the nut vendor) will send back document(s) to the system and the system may automatically assign the first tag (tag=NUT) to that (or those) document(s).

However, in at least one embodiment, the system prompts the user (the template sender or someone associated with the template sender) that a document(s) and/or a document part(s) has been received and also prompt the user to either accept or reject the received document(s) and/or a document part(s). If the user accepts, the system will then automatically assign the tag(s) to that particular template slot(s).

It should be noted that recipients can also send partial documents, multiple documents, etc. at separate times for the particular slot(s). Hence, by allowing the sender's (user sending the template) to be able to review and accept the submissions ensures that there are no redundant submissions, ensures the ability for the template recipients to be able to send additional information, etc.

When a user (e.g., receiver 199) sends a request to a sender 100 (e.g., after the defining of tags and tagging), the sender 100 may define a final level of tags that are applied to all documents received through the template. This tagging process allows the user to automatically file documents received through the system, and can be extended to documents received through other methods, such as integrations with other software that generates documents. Further, this tagging process allows the user to file documents in multiple locations, with each document going into a different location on a request basis.

An example is given in which a requestor (e.g., receiver 199) has a list of multiple documents, for example 5 documents, that the requestor requires from every vendor (sender 100), e.g. a spec sheet (e.g., Document 1), a HAACP plan (e.g., Document 2), a HAACP flowsheet (e.g., Document 3), an allergen disclosure (e.g., Document 4), and a copy of their most recent audit 197 (e.g., Document 5). The requestor (receiver 199) additionally specifies that these each and every document received through this template to be tagged with Vendor Requirements, and additionally specifies that documents received through the HAACP Plan (e.g., Document 2) and HAACP Flowsheet slots are to be (e.g., Document 3 tagged with “HAACP.” Thus, all five documents will be tagged with Vendor Requirements, and HAACP Plan and HAACP flowsheet will also be tagged with HAACP (185). When the requestor sends a request to a specific sender, for example a flour vendor, the requestor can append Flour to the list of tags to be applied to the documents. In other words, when a requestor needs to send request to a specific sender, a tag(s) may be applied that is specific (or associated, or corresponding, etc.) with that specific sender. Since tags represent the filing system architecture, this allows documents to be automatically filed. A second request may be made using the same template to may tag all documents as for example Eggs, and Allergens instead of flour, thereby creating placing the received documents in different locations and allowing flexible reuse of the documents 188. This method can be extended to application integrations in which the application pushing a document to the system specifies the associated tags, either with user input or defaults to a set of base tags such as the application name, allowing for quick integration with applications that generate documents. For example, when the system receives a document(s), the system can automatically scan the document(s) and create and assign tag(s) to each document (and/or each document piece of information) based on any factor(s) (e.g., the sender, the content of the document/information, etc.) and store the document(s). This method is substantially easier than in folder-based filing systems, as in a folder-based file system the paths must be exact.

In addition to the tag-based method/system being a “folderless” system, the document storage method can be used to generate similar documents. Tags allow fast retrieval of groups of related information. It should be noted that while “documents” are being used as examples, “documents” may be a piece of information e.g., an ingredient list, nutritional information, or company information or the like, etc. The document storage method can be expanded to represent a “fileless” method of information management 194 in which the structure stores individual data components (three will be used here as an example but the individual data components/documents are not limited), and users may also update instances of information 194a-c which are propagated to documents that use that information. Such data components may correspond to multiple documents 194x-z. For example, if an user has now two SKUs of mayo, a first SKU for a 12 oz jar of mayo and a second SKU for a 6 oz jar of mayo, the user currently has two sets of documents which correspond to the same information (e.g., the ratio content of ingredients, ingredients, etc.). Changes to the mayo formulation require changes in both sets of information when only one piece of information is changed (e.g., changing the oil type from Canola oil to Vegetable oil). The instance of the information may be changed and propagate that information to the affected documents through grouping related sets of information through tags. Another example is the creation of letters of guarantee (a type of document), in which the contents of the letter may be the same, and only the receiver addressed varies. As such, in standard processes if the user needed to change the body of the letter text, they would need to manually remake each letter since the address differs on each letter. Through this, the letter body can be modified once and changes propagated to all documents affected by the change.

Another benefit of the tag-based document retrieval is that the system/method may decrease the time the system/method takes to send documents to another organization. For example, in a case where a user has a large number of documents to send e.g., 10 documents, and the user must send a set of those documents to two different people where the first receiver requires 6 documents; and the other (second) receiver requires another 6 documents, 4 of which overlap with the first receiver's documents. Conventional sharing methods would require that either a) documents are copied into separate folders and then the folder is shared with the receiver, creating versioning issues or b) each individual document is shared to the receiver. Tag groupings allow the user to quickly select these sets of 6 documents and share all of the relevant documents at once without needing to manually locate individual documents.

Accordingly, in an example, there are ten different documents (D1 through D10) needed to be provided to two different users where the first receiver requires documents D1 through D6 and the second receiver requires documents D3 through D10 whereby documents D3 through D8 are overlapping documents (D3 through D8 are the same documents). In a first option, the sender may tag D1 and D2 with a T1, tag D3 through D8 with T2, and tag D9 and D10 with T3; and send all documents with tags T1 and T2 to the first Receiver and send all documents with tags T2 and T3 to the second Receiver. Additionally, in the first option, the sender may select to send all tag and select to exclude t3 to the first receiver and may select to send all tag and select to exclude t1 to the second receiver. In a second option, the sender may tag D1 through D8 with a T1, tag D3 through D8 with T2, and tag D3 and D10 with T3; and send all documents with tags T1 and T2 to the first Receiver and send all documents with tags T2 and T3 to the second Receiver. Other tagging schemes may be used based on this type of methodology, and mainly the choice of methodology is user specific (user preference).

The system/method also allows the development of autofill 195 across vendor compliance requirements. More specifically, standards have never been developed by competitor products on information requirements for documents, since different entities need different sets of information or may value information differently such as sustainability or labor information. The system herein may use field matching and natural language processing 195 to eliminate the need to standardize, by matching receiver information requirements with the information stored in an entity and dynamically generate the required set of information 196. Such a mechanism could allow automated vendor information management, digital and automatic audits in combination with the blockchain record.

Since graph-based tag systems are an expansion of the capabilities of hierarchical tree-based file systems, tree-based file systems can be quickly converted to a tag-based file system. The fundamental case is simply converting each folder name in the file path of a document into a tag and applying the resulting tags to the relevant document with no relationships between generated tags. For example, the system may intake a folder structure as shown in FIG. 5. By processing the folders into tags, Document 1 and 2 gets tagged with Certifications, Organic, Supplier A, and Document 3 and 4 get tagged with Certifications Organic Supplier B. A more advanced case establishes relationships between the generated tags according to the filepaths used. A graph implementation is key in order for such a hierarchy to be functional, as a folder structure may have multiple similarly named or redundant folders in different locations. A user can then quickly disassociate logically incorrect relationships by managing parent-child relationships. For example, when importing FIG. 5's structure, the system may apply Suppliers as a child tag of Organic Certificates, which need to then be disassociated.

Similar to restricted access to folders, tags can also have restricted access, limiting the ability for a user to see the documents which have been tagged. Such a system can cascade permissions to its subtags, allowing quick permissioning. The implementation of a cascading permission system requires the tags to have an acyclic graph structure, in order to correctly filter down permissions as a cyclic structure would not restrict a user. The graph system is however complicated for users to permission, as granting access to one tag and all of its subtags may grant unexpected access to another child. As a result, both the options for degrees of separation from the granted tag and the ability to select specific subtags should be methods for permissioning.

This system may also implement a signature system 193 on top of document versioning to control document distribution internally to users in an organization. This essentially creates conditional user restricted tags. For example, marketing may not see an updated spec sheet until marketing has garnered all the user defined required signatures in the organization, while operations can see the latest version and work off of it. As a more detailed example, a first user or a first set of users (e.g., the operations department of Company A) can view and edit Document 1. However, a second user or a second set of users (e.g., the marketing department of Company A, the marketing department of Company B, etc.) cannot view nor edit Document 1 until it is confirmed by the system (or the first user/the first set of users) that second user/that second set of users has validly garnered all the second user's defined required signatures to access the system.

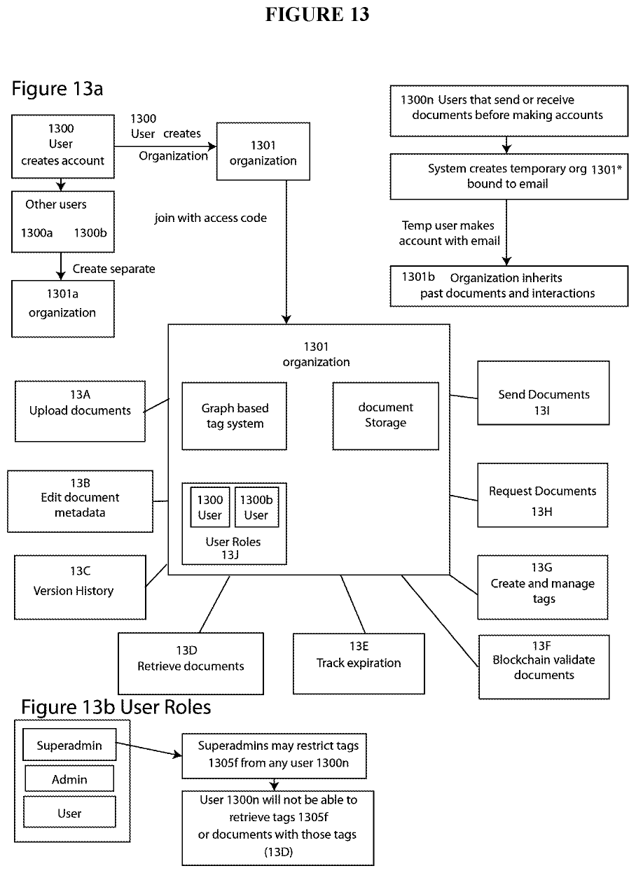

At least FIGS. 13-16 provide a set of process diagrams for an example user flow in the system according to at least one embodiment. A user 1300 begins by signing up to make an account in the system 1399. After the user 1300 creates an account, the user can then create an organization(s) 1301. Organizations may be the storage entity for documents, the users, the tags, the notifications and the logs, etc. At any time, other users (e.g., 1300a, 1300b, . . . 1300n) can also create accounts. The other users can either make separate organizations 1301a (1301b, . . . ), and/or join an organization that exists 1301. The other users can join an existing organization 1301, for example by entering an access code (which may have been provided by system and/or by user 1300). User 1300 can join organization 1301a (1301b, . . . ) in a similar fashion. If an outside user, a sender 1397 or receiver 1396 as an example, does not have an account and interacts with a user 1300 through the system, a temporary organization 1301* can be made by the system for the outside user, the sender 1397 or the receiver 1396, whereby the temporary organization 1301* stores the document (or information) or request that the outside user sent and/or received. The system creates the temporary organization 1301* and can make the outside user bound to the account via the outside's user's email address (or any other data associated only with that outside user). If at any point in the future (after the temporary organization 1301* is created) that outside user, e.g., the sender 1397 or receiver 1396, makes an official account, the outside user can either A) creating a new organization (e.g., 1301n), B) converting 1301* into a permanent organization and renaming it (e.g., 1301* to 1301h), or C) join an existing organization (e.g., 1301). The organization created, selected, or joined by the outside user would receive all permissions (e.g., documents 1306), and requests 1313 that correspond to the new user (e.g., the outside user). Once a user is part of an organization, at any time, one or multiple users 1300n for an organization 1301 can conduct a number of actions in series or in parallel, notated by 13A-13J.

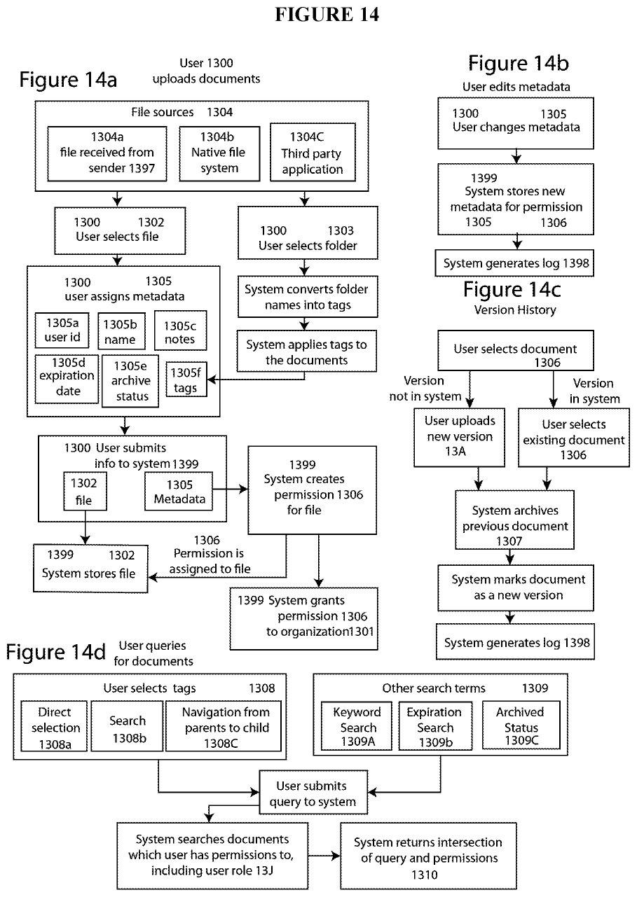

A user (e.g., user 1300) can upload one or a plurality of documents at any time to for example organization 1301 according to the procedure/method of 13A (also see FIG. 14(a)). These documents may be from a variety of sources, including but not limited to the users native file system 1304b, other senders 1304a, from third party applications 1304c, and/or etc. The user 1300 may select one or a plurality of files 1302 from the file source 1304. After the user 1300 selects from the file source 1304, the user 1300 can then define a set of metadata 1305, all of which are optional including but not limited to expiration date, tags, notes, user defined id, etc. The system can default the file name to the provided file name. If a user selects a set of documents 1302n, the metadata defined in 1305 will (e.g., automatically) apply to all selected documents for a single upload. If a user selects a folder 1303 instead of file(s) 1302, the system (e.g., automatically) processes the files by converting the folder names into tags and applying the tags to the relevant documents. The user can then proceed with defining metadata 1305. In the folder case, the set of tags each document has may vary, as each document may have been in a different folder. The user can then submit the file(s) 1302 and metadata 1305 to the system 1399. The system can store the file 1302, and create a permission 1306 granting the permission to user 1300's organization 1301. A permission 1306 is an organization's 1301 unique access to a given file 1302. The permission is comprised of the metadata data 1305 that the user 1300 may define. In this way, multiple organizations may share the same core file 1302, but have different permissions 1306 associated with each document, and therefore different access points and different metadata 1305.

In at least one embodiment, FIG. 14(b) illustrates that a user 1300 can change the metadata 1305 associated with a given permission 1306. However, while the permission's metadata may change, the file 1302 itself remains unchanged. Accordingly, the user 1300 may edit the permissions metadata fields 1305 and then submit the metadata to the system 1399, which replaces the old metadata and generates a system log noting the change 1398.

In at least one embodiment, FIG. 14(c) illustrates that a user 1300 can update a document file 1302 by adding a new version of an old file 1302 to the system. If the new file is not already in the system, the user can proceed according to the procedure/method set forth in 13A (FIG. 14(a)), or the new document can inherit the old document's metadata, bypassing the steps involving 1305 for the procedure/method set forth in 13A (FIG. 14(a)). Alternatively, a new document may exist separately in the system 1399. The user may select the existing document according to the procedure/method set forth in 13D (FIG. 14(d)) and the system archives the old document 1307, marking the new document as a version of the old document. The system then generates a log 1398.

A user 1300 can retrieve a set of documents at any time according to the procedure/method set forth in 13D (FIG. 14(d)). The query submitted by the user is composed of tags 1308 and other search terms 1309, one of which or both must be submitted. A user may select tag(s) through direct selection, for example through an alphabetized glossary, or default tags or pinned tags 1308a, or through search 1308b, or by navigating from parent tags to the desired child tag 1308c, or etc. Multiple tags may also be selected. Separately or in addition to, a user may also define additional search terms 1309 which include for example archived status 1309c (archived, active), keyword search 1309a and expiration search 1309b. The user can then submit the composite query to the system 1399. The system can then search through documents which the organization has a permission 1306 for, and may then apply the various filters additively and return the composite result 1310. The result may be further restricted by user roles, in which a user 1300n may be restricted from viewing certain tags according to the procedure/method set forth in 13J (FIG. 13(b)).

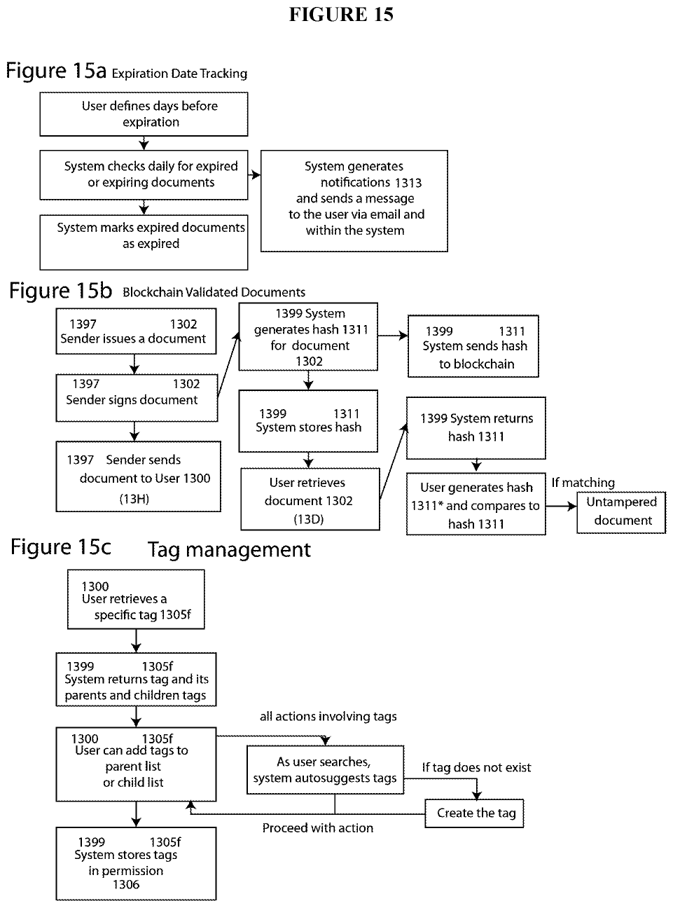

On a regular basis (e.g., planned intervals), the system may track document expiration according to the procedure/method set forth in 13E (FIG. 15(a)). A user may define a parameter days before expiration for the organization 1301. The parameter can have multiple values, e.g. 30 days before and 5 days before, etc. The system 1399 may check daily for expired or expiring soon (calculated based off days before expiration) and the system can mark expired documents as expired. The system can also generate a notification 1313, emailing and generating an internal notification for the user 1300 that a document has expired.

In at least one embodiment, the document 1302 that is stored in the system can be validated and proven immutable by blockchain according to the procedure/method of 13F (FIG. 15(b)). When a sender 1397 issues a document 1302, the sender signs the document and then the document is uploaded to the system as illustrated in the procedure/method of 13A (FIG. 14(a)) and the document is sent to receiver 13J. The system 1399 may then generate a hash 1311 of the document 1302. The hash is then published by the system 1399 in a third party blockchain, and the system stores the returned block record. When a user retrieves document 1302, the hash and block record may also be returned. A user can then generate another hash 1311* and compare it to the original 1311, proving that the document has not been altered if the hash matches.

In at least one embodiment, a user can alter tags at any point, including their relationships as illustrated in procedure/method of 13G (FIG. 15(c)). The user 1300 may select a tag via 1308, and the system may return the tag information as well as the names of the parent or child tags of the selected tag 1305f. The user can then add and/or remove tags from the parent and/or child tag lists, which is stored in the tag graph for the organization. For all tag operations, including but not limited to tagging documents, adding tags to templates, or creating relationships, as a user searches for the tag the system 1399 may autosuggest tags based off of the current query. If a tag does not exist, the system can create the tag then proceeds with the desired operation.

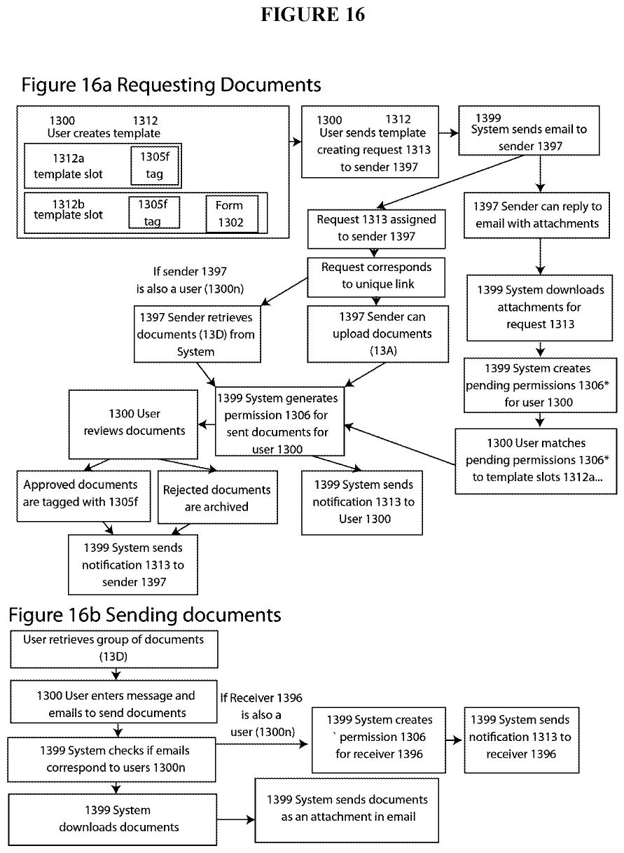

In at least one embodiment, a user 1300 may request documents from any other person as long as the user has their email as illustrated in procedure/method of 13H (FIG. 16(a)). The user can first creates a template 1312, which is composed of template slots 1312a . . . b. Each template slot may have associated tags 1305f. The user can then send the template 1312 to a sender 1397 by entering their email (or any identification), and optionally specifying additional tags 1305f. The system can create a request 1313 for sender 1397, creating a temporary organization if the sender is not a (known) user. Sender 1397 may reply in multiple ways. For example, a sender may reply directly to the email, which contains a unique code. The system 1399 can then download attachments, and create pending permissions 1306* for the request 1313. The user can then match the pending permissions to the template slots. The sender 1397 can also use a web interface through a unique link to reply to request 1313. The web interface essentially consists of a form composed of the template slots. The sender can upload document(s) from their computer according to the procedure/method set forth in 13A (FIG. 14(a)), without the ability to add metadata 1305, or if they are a user 1300, can retrieve document(s) stored in the system (13D, FIG. 14(d)). The sender 1397 can select document(s), then can submit the form to the system 1399. The system can generate permissions 1306 for each document submitted and can grant them to the receiver, user 1300. The system can notify user 1300, and the user 1300 can review the document(s). The user may accept and/or reject received document(s), sending corresponding notification(s) 1313 back to the sender. An accepted document(s) is/are tagged with the predefined tag(s) and can then be retrieved according to the procedure/method set forth in 13D (FIG. 14(d)).

In at least one embodiment, a user 1300 can send document(s) 1302 to a receiver 1396 at any time according to the procedure/method set forth in 131 (FIG. 16(b)). The user can retrieve a group of documents according to the procedure/method set forth in 13D (FIG. 14(d)) and enter email(s) and/or optional message(s) to send the document(s). The system 1399 can check if the email(s) correspond to users 1300n. Regardless if the receiver email(s) is/are user(s), the system can download the document(s) and send the receivers 1396 an email with the document(s) as attachment(s). If the receiver is also a user, the system can create a permission 1306 for the file 1302 and grant it to the receiver 1396. The system can then notify the receiver 1313.

In at least one embodiment, user roles can also be defined for various users that are part of an organization 1301. Base classes include superadmins, which can modify any information including other user information, admins which can modify document(s) and tag(s), and users which are read-only and download-only. Superadmins can also further restrict other users' ability to retrieve tag(s) and therefore document(s) by restricting access capability of certain tags. Those tags are ignored in processes like the ones set forth in the procedures/methods of 13D or 13G (FIG. 14(d) or 15(c)).

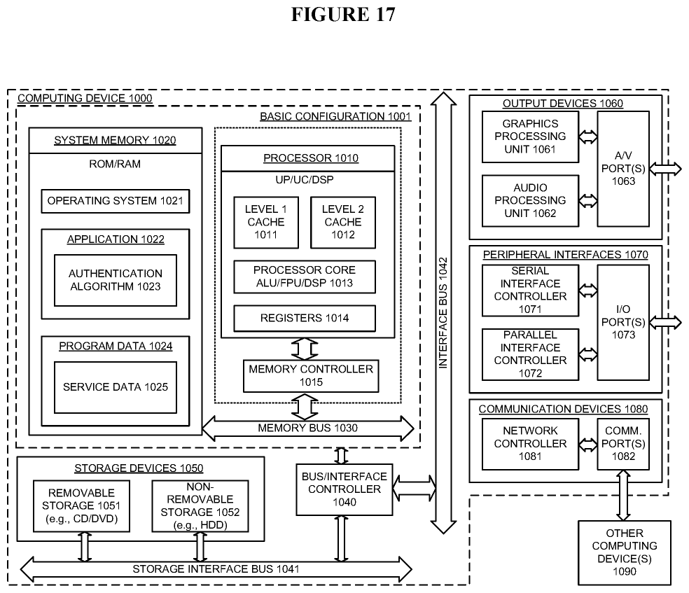

FIG. 17 is a circuit diagram of one aspect of a computing device/controller 1000 that works in conjunction with the elements of the present disclosure. In a very basic configuration of computing device 1000, the computing device 1000 typically includes one or more processors 1010 and a system memory 1020. A memory bus 1030 can be used for communications between the processor 1010 and the system memory 1020.

Depending on the desired configuration, the one or more processor 1010 of computing device 1000 can be of any type including but not limited to a microprocessor, a microcontroller, a digital signal processor, or any combination thereof. Processor 1010 can include one more levels of caching, such as a level one cache 1011 and a level two cache 1012, a processor core 1013, and registers 1014. The processor core 1013 can include an arithmetic logic unit (ALU), a floating point unit (FPU), a digital signal processing core (DSP Core), or any combination thereof. A memory controller 1015 can also be used with the processor 1010, or in some implementations the memory controller 1015 can be an internal part of the processor 1010.

Depending on the desired configuration, the system memory 1020 can be of any type including but not limited to volatile memory (such as RAM), non-volatile memory (such as ROM, flash memory, etc.) or any combination thereof. System memory 1020 typically includes an operating system 1021, one or more applications 1022, and program data 1024. Application 1022 includes an authentication algorithm 1023. Program Data 1024 includes service data 1025.

Computing device 1000 can have additional features or functionality, and additional interfaces to facilitate communications between the basic configuration 1001 and any required devices and interfaces. For example, a bus/interface controller 1040 can be used to facilitate communications between the basic configuration 1001 and one or more data storage devices 1050 via a storage interface bus 1041. The data storage devices 1050 can be removable storage devices 1051, non-removable storage devices 1052, or a combination thereof. Examples of removable storage and non-removable storage devices include magnetic disk devices such as flexible disk drives and hard-disk drives (HDD), optical disk drives such as compact disk (CD) drives or digital versatile disk (DVD) drives, solid state drives (SSD), and tape drives to name a few. Example computer storage media can include volatile and nonvolatile, removable and non-removable media implemented in any method or technology for storage of information, such as computer readable instructions, data structures, program modules, or other data

System memory 1020, removable storage 1051 and non-removable storage 1052 are all examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by the computing device 1000. Any such computer storage media can be part of the computing device 1000.

Computing device 1000 can also include an interface bus 1042 for facilitating communication from various interface devices (e.g., output interfaces, peripheral interfaces, communication interfaces, etc.) to the basic configuration 1001 via the bus/interface controller 1040. Example output devices 1060 include a graphics processing unit 1061 and an audio processing unit 1062, which can be configured to communicate to various external devices such as a display or speakers via one or more A/V ports 1063. Example peripheral interfaces 1070 include a serial interface controller 1071 or a parallel interface controller 1072, which can be configured to communicate with external devices such as input devices (e.g., keyboard, mouse, pen, voice input device, touch input device, etc.) or other peripheral devices (e.g., printer, scanner, etc.) via one or more I/O ports 1073. An example communication device 1080 includes a network controller 1081, which can be arranged to facilitate communications with one or more other computing devices 1090 over a network communication via one or more communication ports 1082. The communication connection is one example of a communication media. Communication media may typically be embodied by computer readable instructions, data structures, program modules, or other data in a modulated data signal, such as a carrier wave or other transport mechanism, and includes any information delivery media. A “modulated data signal” can be a signal that has one or more of its characteristics set or changed in such a manner as to encode information in the signal. By way of example, and not limitation, communication media can include wired media such as a wired network or direct-wired connection, and wireless media such as acoustic, radio frequency (RF), infrared (IR) and other wireless media. The term computer readable media as used herein can include both storage media and communication media.

It should be noted that the specifying circuit 112, the buffer specifier 114, the segmenter 311, the transformer 312, the periodogram computer 313, the delay assessment circuit 118, the pre-processors 110 and 111, the first and second threshold circuit 130 and 131, and/or the first and the second shift register 150, 151 may work in conjunction with computing device 600. In addition, it should be noted that the specifying circuit 112, the buffer specifier 114, the segmenter 311, the transformer 312, the periodogram computer 313, the delay assessment circuit 118, the pre-processors 110 and 111, the first and second threshold circuit 130 and 131, and/or the first and the second shift register 150, 151 may be comprised directly of the elements of computing device 1000 (i.e., elements 1010 and/or 1020).

Computing device 1000 can be implemented as a portion of a small-form factor portable (or mobile) electronic device such as a cell phone, a personal data assistant (PDA), a personal media player device, a wireless web-watch device, a personal headset device, an application specific device, or a hybrid device that include any of the above functions. Computing device 1000 can also be implemented as a personal computer including both laptop computer and non-laptop computer configurations.

There is little distinction left between hardware and software implementations of aspects of systems; the use of hardware or software is generally (but not always, in that in certain contexts the choice between hardware and software can become significant) a design choice representing cost versus efficiency tradeoffs. There are various vehicles by which processes and/or systems and/or other technologies described herein can be effected (e.g., hardware, software, and/or firmware), and the preferred vehicle will vary with the context in which the processes and/or systems and/or other technologies are deployed. For example, if an implementer determines that speed and accuracy are paramount, the implementer may opt for a mainly hardware and/or firmware vehicle; if flexibility is paramount, the implementer may opt for a mainly software implementation. In one or more other scenarios, the implementer may opt for some combination of hardware, software, and/or firmware.

The foregoing detailed description has set forth various embodiments of the devices and/or processes via the use of block diagrams, flowcharts, and/or examples. Insofar as such block diagrams, flowcharts, and/or examples contain one or more functions and/or operations, it will be understood by those within the art that each function and/or operation within such block diagrams, flowcharts, or examples can be implemented, individually and/or collectively, by a wide range of hardware, software, firmware, or virtually any combination thereof.

In at least one embodiment, several portions of the subject matter described herein may be implemented via Application Specific Integrated Circuits (ASICs), Field Programmable Gate Arrays (FPGAs), digital signal processors (DSPs), or other integrated formats. However, those skilled in the art will recognize that some aspects of the embodiments disclosed herein, in whole or in part, can be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure.

In addition, those skilled in the art will appreciate that the mechanisms of the subject matter described herein are capable of being distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a Compact Disc (CD), a Digital Video Disk (DVD), a digital tape, a computer memory, etc.; and a transmission type medium such as a digital and/or an analog communication medium (e.g., a fiber optic cable, a waveguide, a wired communications link, a wireless communication link, etc.).

Those skilled in the art will recognize that it is common within the art to describe devices and/or processes in the fashion set forth herein, and thereafter use engineering practices to integrate such described devices and/or processes into data processing systems. That is, at least a portion of the devices and/or processes described herein can be integrated into a data processing system via a reasonable amount of experimentation. Those having skill in the art will recognize that a typical data processing system generally includes one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors (e.g., feedback for sensing position and/or velocity; control motors for moving and/or adjusting components and/or quantities). A typical data processing system may be implemented utilizing any suitable commercially available components, such as those typically found in data computing/communication and/or network computing/communication systems.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

Exemplary embodiments are shown and described in the present disclosure. It is to be understood that the embodiments are capable of use in various other combinations and environments and are capable of changes or modifications within the scope of the inventive concept as expressed herein. Some such variations may include using programs stored on non-transitory computer-readable media to enable computers and/or computer systems to carry our part or all of the method variations discussed above. Such variations are not to be regarded as departure from the spirit and scope of the invention, and all such modifications as would be obvious to one skilled in the art are intended to be included within the scope of the following claims.

1. An apparatus comprising:
a receiving circuit and/or device configured and/or programmed to receive at least:
a first document from a first user, wherein the first user is at a first location,
a second document from a second user, wherein the second user is at a second location, and
a third document from a third user, wherein the third user is at a third location;
a partitioning circuit and/or device configured and/or programmed to at least:
receive said first document, said second document and said third document from said receiving circuit and/or device,
perform character recognition on said first document to produce a first result being a first text document,
perform character recognition on said second document to produce a second result being a second text document,
perform character recognition on said third document to produce a third result being a third text document,
automatically defining fields produced by text in said first document, said second document and said third document;
automatically assigning tags based on said fields produced to said first document, said second document and said third document, wherein
at least a first tag is assigned to said first document based on a first field produced from the first document,
at least a second tag is assigned to said second document based on a second field produced, and
at least a third tag is assigned to said third document based on a third field produced; and
a storage circuit and/or device configured and/or programmed to store at least:
the first document that is tagged with the first tag,
the second document that is tagged with the second tag, and
the third document that is tagged with the third tag.

2. The apparatus according to claim 1, the apparatus further comprising:
a transmitting and/or displaying circuit and/or device, based on receiving a single instruction to i) transmit documents tagged with the first tag and the second tag to one of the first user, the second user, the third user, a fourth user or a fifth user and to ii) transmit documents tagged with the second tag and the third tag to another of the first user, the second user, the third user, the fourth user or the fifth user, configured and/or programmed to:
simultaneously transmit:
said first document and said second document which are individually tagged with the first tag and the second tag to said one of the first user, the second user, the third user, the fourth user or the fifth user, and
said second document and said third document which are individually tagged with the second tag and the third tag to said another of the first user, the second user, the third user, the fourth user or the fifth user.

3. The apparatus according to claim 1, the apparatus further comprising:
a transmitting and/or displaying circuit and/or device configured and/or programmed to simultaneously transmit a plurality of documents to a recipient user in response to receiving i) a selection of a plurality of tags and ii) a selection of the recipient user.

4. The apparatus according to claim 1, the apparatus further comprising:
a transmitting and/or displaying circuit and/or device configured and/or programmed to simultaneously transmit a plurality of documents to a plurality of recipient users in response to receiving i) a selection of a plurality of tags and ii) a selection of the plurality of recipient users.

5. The apparatus according to claim 1, wherein
the storage circuit and/or device is configured and/or programmed to store a fourth document that is tagged with a fourth tag,
said first tag is assigned as a parent tag to said second tag,
said fourth tag is assigned as a child tag to said second tag,
said third tag is assigned as a parent tag to said fourth tag;
a transmitting and/or displaying circuit and/or device is configured and/or programmed to:
transmit and/or display said second document in response to one of the first user, the second user, the third user, a fourth user or a fifth user selecting the first tag,
transmit and/or display said fourth document in response to said one of the first user, the second user, the third user, the fourth user or the fifth user selecting the second tag, and
transmit and/or display said fourth document in response to another of the first user, the second user, the third user, the fourth user or the fifth user selecting the third tag.

6. The apparatus according to claim 1, wherein
the transmitting and/or displaying circuit and/or device is configured and/or programmed to transmit and/or display said fourth document in response to another of the first user, the second user, the third user, the fourth user or the fifth user selecting the fourth tag.

7. The apparatus according to claim 1, wherein
said first tag is assigned as a parent tag to said second tag; and
a transmitting and/or displaying circuit and/or device is configured and/or programmed to:
transmit and/or display said second document in response to one of the first user, the second user, the third user, a fourth user or a fifth user selecting the second tag after selecting the first tag, and
transmit and/or display said second document in response to another of the first user, the second user, the third user, a fourth user or a fifth user selecting only the second tag.

8. The apparatus according to claim 1, wherein
said first tag is assigned as a parent tag to said second tag; and
a transmitting and/or displaying circuit and/or device is configured and/or programmed to:
transmit and/or display said second document in response to one of the first user, the second user, the third user, a fourth user or a fifth user selecting the second tag after selecting the first tag, and
transmit and/or display said second document in response to another of the first user, the second user, the third user, a fourth user or a fifth user selecting the second tag without a selection of the first tag.

9. The apparatus according to claim 1, the apparatus in a system that further comprises:
a controller circuit and/or device configured and/or programmed to:
assign a unique ID to each user associated with the system,
generate an identification of a piece of data to uniquely identify a document or a piece of document information in response to the document or the piece of document information being posted or stored in said storage circuit and/or device, and
determine and/or confirm whether data of said first document has been changed by comparing a newly generated identification for said first document to a previously generated identification for said first document.

10. The apparatus according to claim 1, the apparatus in a system that further comprises:
a controller circuit and/or device configured and/or programmed to:
assign a unique ID to each user associated with the system, and
generate an identification of a piece of data to uniquely identify a document or a piece of document information in response to the document or the piece of document information being posted or stored in said storage circuit and/or device, subsequent publication of the unique identifier of the piece of data to an immutable record, then at any time a user may determine and/or confirm whether data of said first document has been changed by comparing a newly generated identification for said first document to a previously generated identification for said first document.

11. The apparatus according to claim 1, wherein
the storage circuit and/or device is configured and/or programmed to store a fourth document that is tagged with a fourth tag,
said first tag is assigned as a parent tag to said second tag,
said fourth tag is assigned as a child tag to said second tag, and
the receiving circuit and/or device is configured and/or programmed to receive a tagging instruction from a user; and
the apparatus further comprising:
a controller circuit and/or device configured and/or programmed to block or restrict the ability to assign a tagging relationship where either i) the first tag is to be a child tag of the fourth tag or ii) the fourth tag is to be a parent tag of the first tag.

12. The apparatus according to claim 11, the apparatus further comprising:
a transmitting and/or displaying circuit and/or device configured and/or programmed to transmit and/or display an error message in response to the controller blocking or restricting the ability to assign the tagging relationship where either i) the first tag is to be a child tag of the fourth tag or ii) the fourth tag is to be a parent tag of the first tag.

13. An apparatus for handling document request templates, the apparatus comprising:
a receiving circuit and/or device configured and/or programmed to receive:
at least a set of documents from a first user, and
a value corresponding to N number of template slots to be used in a template; and
a transmitting circuit and/or device configured and/or programmed to transmit the template with at least said set of documents to a second user, wherein
at least one document is sent in at least one of said N template slots,
said set of documents includes at least N documents,
the template includes N template slots,
N being a value equal to or greater than 1,
said receiving circuit and/or device is configured and/or programmed to receive an edited template from the second user,
an assignment circuit and/or device configured and/or programmed to assign temporary tag(s) to each individual template slot of the set of documents based on the edited template received from the second user,
said transmitting circuit and/or device is configured and/or programmed to transmit, to the second user, the assigned temporary tags,
said receiving circuit and/or device is configured and/or programmed to receive, from the second user, permanent tag(s) being edited version of said temporary tag(s), and
said assignment circuit and/or device is configured and/or programmed to assign the permanent tag(s) to said set of documents by adding, deleting, and/or replacing tag assignments.

14. An apparatus for handling document request templates, the apparatus comprising:
a communication circuit and/or device configured and/or programmed to:
receive, from a first user, a value corresponding to N number of template slots to be used in a template,
receive, from the first user, a first assignment or a first label corresponding to a first slot,
receive, from the first user, a second assignment or a second label corresponding to a second slot,
receive, from the first user, a first tag corresponding to the first slot,
receive, from the first user, a second tag corresponding to the second slot,
receive, from the first user, a third tag corresponding to all of said N slots,
receive, from a second user, a first document or a first set of documents corresponding to the first slot, and
receive, from the second user, a second document or a second set of documents corresponding to the second slot; and
a controller circuit and/or device configured and/or programmed to:
automatically convert and assign the first assignment or the first label as a fourth tag to said received first document or said received first set of documents corresponding to the first slot,
automatically convert and assign the second assignment or the second label as a fifth tag to said received second document or said received second set of documents corresponding to the second slot,
automatically assign the first tag to said received first document or said received first set of documents corresponding to the first slot,
automatically assign the second tag to said received second document or said received second set of documents corresponding to the second slot, and
automatically assign the third tag to both said received first document or said received first set of documents corresponding to the first slot and said received second document or said received second set of documents corresponding to the second slot.

15. The apparatus according to claim 14, wherein
the communication circuit and/or device configured and/or is further programmed to receive, from the first user, a sixth tag that the first user assigned only to the second user at the time the first user sent the template to the second user, and
the controller circuit and/or device configured and/or is further programmed to automatically assign the sixth tag to all documents or all set of documents received from the second user that the first user send via the template, and
said all documents received or said all set of documents received from the second user includes at least said received first document or said received first set of documents and said received second document or said received second set of documents.

16. The apparatus according to claim 15, wherein
said controller circuit and/or device configured and/or is further programmed to automatically assign the sixth tag to said all documents or said all set of documents received from the second user that the first user send via the template only in response to the communication circuit and/or device, and
receiving an acknowledgement from the first user that the system is permitted to accept the second user's submission of aid all documents or said all set of documents received from the second user.

17. An apparatus for a file sharing, retrieval and management system using hierarchical tagging with permissions, the apparatus comprising:
a hierarchical list of tags;
a plurality of files;
a hierarchical tag management facility; and
a tag permissions facility; wherein
each of said plurality of files is tagged by one or more tags in said hierarchical list of tags,
said hierarchical tag facility is used to create and manage said hierarchical list of tags,
said tag permissions facility is activated in response to an administrator selecting one or multiple tags,
said administrator is a user having rights to facilities to configure said file sharing system,
said tags permissions facility is used to change permissions to one or more groups of users to access one or more files tagged with a selected set of tags,
said hierarchical list of tags includes child tags and parent tags, and
said hierarchical list of tags restricts assignment of a child tag to be given to any ancestry parent tags and said hierarchical list of tags restricts assignment of a parent tag to be given to any direct heir tags to ensure hierarchical list of tags is structured only as a directed acyclic graph structure that does not form a cycle or a closed loop between any tag relationships.

18. A method comprising:
receiving a first document from a first user, wherein the first user is at a first location;
receiving a second document from a second user, wherein the second user is at a second location;
receiving a third document from a third user, wherein the third user is at a third location;
performing character recognition on said first document to produce a first result being a first text document;
performing character recognition on said second document to produce a second result being a second text document;
performing character recognition on said third document to produce a third result being a third text document;
automatically defining fields produced by text in said first document, said second document and said third document;
automatically assigning tags based on said fields produced to said first document, said second document and said third document, wherein
at least a first tag is assigned to said first document based on a first field produced from the first document,
at least a second tag is assigned to said second document based on a second field produced, and
at least a third tag is assigned to said third document based on a third field produced;
storing the first document that is tagged with the first tag;
storing the second document that is tagged with the second tag; and
storing the third document that is tagged with the third tag.

19. A non-transitory computer readable medium having instructions stored thereon, such that when the instructions are read and executed by one or more processors, said one or more processors is configured to perform the method according to claim 18.

20. A method for handling document request templates, the method comprising:
receiving at least a set of documents from a first user;
receiving a value corresponding to N number of template slots to be used in a template;
transmitting the template with at least said set of documents to a second user, wherein
at least one document is sent in at least one of said N template slots,
said set of documents includes at least N documents,
the template includes N template slots,
N being a value equal to or greater than 1;
receiving an edited template from the second user;
assigning temporary tag(s) to each individual template slot of the set of documents based on the edited template received from the second user;
transmitting, to the second user, the assigned temporary tags;
receiving, from the second user, permanent tag(s) being edited version of said temporary tag(s); and
assigning the permanent tag(s) to said set of documents by adding, deleting, and/or replacing tag assignments.

21. A non-transitory computer readable medium having instructions stored thereon, such that when the instructions are read and executed by one or more processors, said one or more processors is configured to perform the method according to claim 20.

22. A method for handling document request templates, the method comprising:
receiving, from a first user, a value corresponding to N number of template slots to be used in a template;
receiving, from the first user, a first assignment corresponding to a first slot;
receiving, from the first user, a second assignment corresponding to a second slot;
receiving, from the first user, a first tag corresponding to the first slot;
receiving, from the first user, a second tag corresponding to the second slot;
receiving, from the first user, a third tag corresponding to all of said N slots;
receiving, from a second user, a first document or a first set of documents corresponding to the first slot;
receiving, from the second user, a second document or a second set of documents corresponding to the second slot;
automatically converting and assigning the first assignment as a fourth tag to said received first document or said received first set of documents corresponding to the first slot;
automatically converting and assigning the second assignment as a fifth tag to said received second document or said received second set of documents corresponding to the second slot;
automatically assigning the first tag to said received first document or said received first set of documents corresponding to the first slot;
automatically assigning the second tag to said received second document or said received second set of documents corresponding to the second slot; and
automatically assigning the third tag to both said received first document or said received first set of documents corresponding to the first slot and said received second document or said received second set of documents corresponding to the second slot.

23. A non-transitory computer readable medium having instructions stored thereon, such that when the instructions are read and executed by one or more processors, said one or more processors is configured to perform the method according to claim 22.

24. A method for a file sharing, retrieval and management system using hierarchical tagging with permissions, the method comprising:
tagging each of a plurality of files by one or more tags in a hierarchical list of tags, wherein
said hierarchical tag facility is used to create and manage said hierarchical list of tags;
changing permissions to one or more groups of users to access one or more files tagged with a selected set of tags, wherein
said hierarchical list of tags includes child tags and parent tags; and
restricting assignment of a child tag to be given to any ancestry parent tags and said hierarchical list of tags restricts assignment of a parent tag to be given to any direct heir tags to ensure hierarchical list of tags is structured only as a directed acyclic graph structure that does not form a cycle or a closed loop between any tag relationships.

25. A non-transitory computer readable medium having instructions stored thereon, such that when the instructions are read and executed by one or more processors, said one or more processors is configured to perform the method according to claim 24.
